(19) United States
(12) Patent Application Publication
(10) Pub. No.: US 2018/0189817 A1
(43) Pub. Date: Jul. 5, 2018

(54) UTILIZING NETWORKING SYSTEM OFFERS OFFLINE

(71) Applicant: Facebook, Inc., Menlo Park, CA (US)

(72) Inventors: Dan Barak, Redwood City, CA (US); John Stephen Ketchpaw, Seattle, WA (US)

(21) Appl. No.: 15/395,588

(22) Filed: Dec. 30, 2016

(51) Int. Cl. G06Q 30/02; G06Q 30/06

(52) U.S. Cl. CPC G06Q 30/0238; G06Q 30/0239; G06Q 30/0635

(57) ABSTRACT

The present disclosure is directed toward systems and methods for identifying and providing offers to networking system users for use in offline purchases. For example, systems and methods described herein detect when a networking system user has initiated an offline purchase at a merchant's physical point of sale. Systems and methods described herein then provide one or more offers that are applicable to the initiated purchase. In response to the user selecting one or more of the provided offers, systems and methods described herein also generate an offer report for the merchant detailing how the merchant's offers are being utilized by networking system users.

### CROSS REFERENCE TO RELATED APPLICATIONS

N/A

### BACKGROUND

Merchants find it increasingly effective to make various offers available in certain online forums. For example, a merchant may present offers to users via a networking system. The networking system typically displays the merchant's offers within a user's networking system newsfeed and/or in other locations within the framework of networking system graphical user interfaces (e.g., in banners along the sides of a graphical user interface). The user may select and save offers for later use.

A disconnect occurs, however, when the user makes a purchase at a point of sale offline. To illustrate, a networking system user may have saved an offer to his networking system account for 10% off a shirt that can be redeemed either on the merchant's website or at one of the merchant's physical locations. Later, when the user decides to purchase the shirt at the merchant's local point of sale the user may easily forget that he saved an offer to his networking system account that is applicable to the purchase. Similarly, even if the user remembers that he has saved an applicable offer, he may not have access to his social networking account in order to redeem the saved offer. Thus, a user frequently misses out on opportunities to redeem offers saved to the user's networking system account when making purchases offline in physical retail stores.

As such, there are a number of disadvantages in conventional systems for providing offers to networking system users.

### SUMMARY

One or more embodiments described herein provide benefits and/or solve one or more of the foregoing or other problems in the art with systems and methods for enabling networking system users to redeem offers presented via the networking system in connection with offline purchases. For example, the disclosed system recognizes when a user has initiated a purchase transaction at a merchant's physical location based on information received from a payment processor used by the merchant. In one or more embodiments, the systems and methods described herein use the information received from the payment processor to identify one or more offers available and applicable to the initiated purchase.

Additionally, systems and methods described herein further update the networking system user's account once the user has redeemed an offer offline. In response to the user or merchant selecting an offer for application to a purchase at a physical point of sale, systems and methods described herein update the user's networking system account such that the user cannot utilize the offer beyond the offer's terms of use. Furthermore, systems and methods described herein generate a report for the merchant including information relevant to the one or more offers the merchant is promoting via the networking system.

Additional features and advantages of the present application will be set forth in the description which follows, and in part will be obvious from the description, or may be learned by the practice of such exemplary embodiments. The features and advantages of such embodiments may be realized and obtained by means of the instruments and combinations particularly pointed out in the appended claims. These and other features will become more fully apparent from the following description and appended claims, or may be learned by the practice of such exemplary embodiments as set forth hereinafter.

### BRIEF DESCRIPTION OF THE DRAWINGS

In order to describe the manner in which the above recited and other advantages and features can be obtained, a more particular description of the aspects of one or more embodiments briefly described above will be rendered by reference to specific embodiments thereof that are illustrated in the appended drawings. It should be noted that the figures are not drawn to scale, and that elements of similar structure or function are generally represented by like reference numerals for illustrative purposes throughout the figures. Understanding that these drawings depict only typical embodiments and are not therefore to be considered to be limiting of scope, one or more embodiments will be described and explained with additional specificity and detail through the use of the accompanying drawings in which:

FIG. 1 illustrates a schematic diagram of an offer management system in accordance with one or more embodiments;

FIGS. 2A and 2B illustrate a sequence diagram showing interactions between various components of the offer management system in accordance with one or more embodiments;

FIGS. 3A and 3B illustrate a series of graphical user interfaces of the offer management system in accordance with one or more embodiments;

FIG. 4 illustrates a detailed schematic diagram of the offer management system in accordance with one or more embodiments;

FIG. 5 illustrates a flowchart of a series of acts in a method of providing offers to a networking system user during an offline purchase in accordance with one or more embodiments;

FIG. 6 illustrates a block diagram of an exemplary computing device in accordance with one or more embodiments;

FIG. 7 is an example network environment of a networking system in accordance with one or more embodiments; and

FIG. 8 illustrates a social graph in accordance with one or more embodiments.

### DETAILED DESCRIPTION

One or more embodiments described herein provide benefits and/or solve one or more of the foregoing or other problems in the art with systems and methods for utilizing networking system offers offline. For example, the offer management system detects when a networking system user initiates a transaction offline at a merchant's physical point of sale (“POS”). In one or more embodiments, the offer management system identifies networking system offers that can apply to the user's initiated transaction, and provides information to display those offers at the POS. The merchant or the user may then select an offer to apply to the transaction. In at least one embodiment, the offer management system then updates the user's account to reflect the use of the offer.

To illustrate, in one example a merchant partners with the offer management system in order to provide offers to networking system users. For each offer that the merchant would like to make available, the offer management system can generate an offer object (e.g., a structured object including content and information associated with the offer), which the offer management system then inserts into users' newsfeeds and in other locations within the display framework of a networking system.

At this point, a networking system user may navigate through various features of the networking system (e.g., the user's newsfeed, displayed banner ads, etc.) and interact with one or more of the merchant's offer objects. In one or more embodiments, the user interacts with an offer object by clicking or tapping on the offer object to learn more about the offer in a different graphical user interface, and/or to save the offer for later use. In at least one embodiment, when the user saves the offer for later, the offer management system adds the associated offer to a list of stored offers associated with the user's networking system account that the user can access within the networking system.

In at least one embodiment, the offer management system tracks and analyzes the user's activities within the networking system in order to identify additional offers that might be of interest to the user. For example, in one or more embodiments the offer management system can determine one or more characteristics of a networking system user based on the user's activities within the networking system. Accordingly, in response to determining one or more characteristics of the networking system user, the offer management system can identify one or more offers that are appropriate for the user based on the user's characteristics.

At a later point, after the user has stored a merchant's offer to his networking system account, the user may decide to make a purchase from the merchant at physical POS associated with the merchant. In one or more embodiments, the merchant is partnered with a payment processing system. As used herein, a payment processing system refers to a third party appointed by the merchant to handle non-cash transactions. For example, a payment processing system may receive a notification of an initiated purchase from a merchant. The notification can include a credit card number and other transaction information from a merchant (e.g., via a card swipe at a merchant-computing device). The payment processing system then processes the transaction according to the notification. In at least one embodiment, the payment processing system performs an initial registration process with the networking system that links payment processing system user accounts with networking system user accounts.

Thus, in one or more embodiments described herein, in response to receiving a purchase notification from the merchant, the payment processing system can request offer information from the offer management system that is applicable to the initiated purchase. For example, in at least one embodiment, the payment processing system provides identification information to the offer management system, which the offer management system utilizes to identify one or more offers saved by the user that are applicable to the user's offline purchase.

After identifying one or more offers, the offer management system can provide the identified offers to the payment processing system. In at least one embodiment, the payment processing system can automatically apply the identified offers to the transaction. Alternatively, the payment processing system can provide the identified offers to the merchant. In that case, the merchant can display the identified offers for the user to select one or more of the identified offers. In response to a selection of at least one of the displayed offers by the user, the payment processing system can then process the purchase transaction with the selected offer applied.

Once the purchase transaction with the applied offer has been completed, the networking system application can notify the networking system user that the offer was successfully applied to the transaction. In one or more embodiments, the offer management system also updates the networking system user's account to reflect the use of the offer. For example, if the offer is a one-time-only offer, the offer management system will delete the offer from the user's account. If the offer is a “punch card” type offer (e.g., buy 10 sandwiches get your 11^{th} sandwich free!”), the offer management system will update the offer object to reflect that the user has utilized the offer.

Furthermore, in response to the successful use of the offer, the offer management system also generates or updates an offer report for the merchant. For example, the offer management system can generate an offer report that includes information regarding each offer promoted by the merchant via the networking system. The offer report can include conversion rates for each offer, redemption counts for each offer, a number of offers still available, demographic information associated with networking system users who have redeemed each offer, and so forth. The offer management system can provide an offer report to the merchant hourly, daily, weekly, etc.

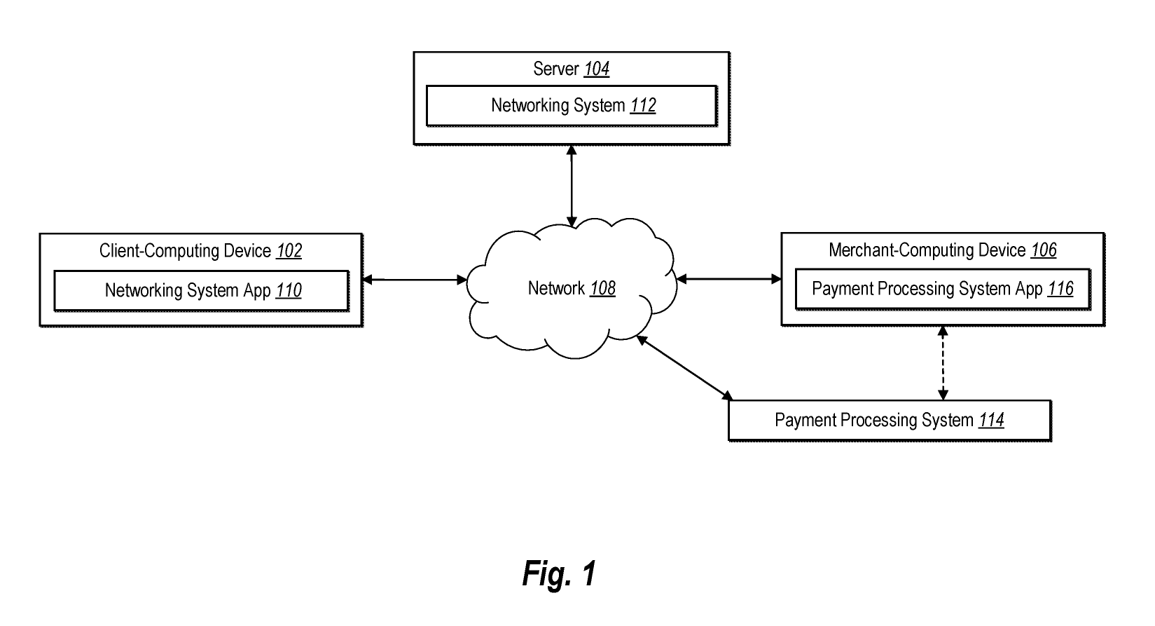

FIG. 1 illustrates an example block diagram of an environment for implementing the offer management system 100. As illustrated in FIG. 1, the offer management system 100 includes the client-computing device 102, the server 104, the merchant-computing device 106, and the payment processing system 114, which are communicatively coupled through a network 108. As shown in FIG. 1, the client-computing device 102 includes the networking system application 110. Additionally shown in FIG. 1, the merchant-computing device 106 includes the payment processing system application 116. Further, the server 104 includes a networking system 112.

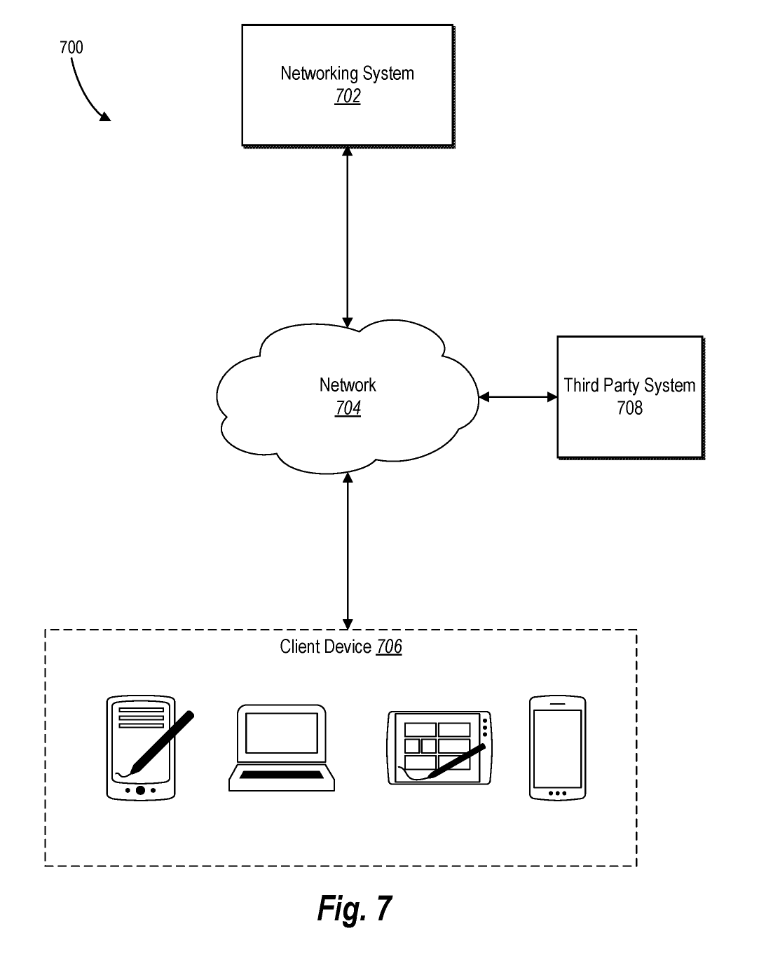

The client-computing device 102, the merchant-computing device 106, the payment processing system 114, and the server 104 communicate via the network 108, which may include one or more networks and may use one or more communication platforms or technologies suitable for transmitting data and/or communication signals. In one or more embodiments, the network 108 includes the Internet or World Wide Web. The network 108, however, can include various other types of networks that use various communication technologies and protocols, such as a corporate intranet, a virtual private network (“VPN”), a local area network (“LAN”), a wireless local network (“WLAN”), a cellular network, a wide area network (“WAN”), a metropolitan area network (“MAN”), or a combination of two or more such networks. Although FIG. 1 illustrates a particular arrangement of the client-computing device 102, the server 104, the merchant-computing device 106, the payment processing system 114, and the network 108, various additional arrangements are possible. For example, the client-computing device 102 may directly communicate with the networking system 112, bypassing the network 108. Additional details relating to the network 108 are explained below with reference to FIG. 7.

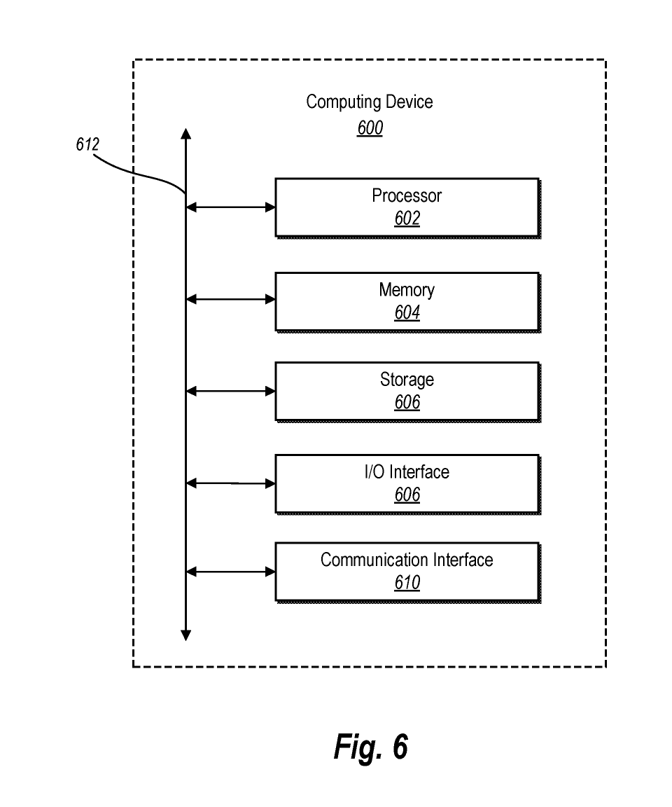

In one or more embodiments, the client-computing device 102 is one or more of various types of computing devices. For example, the client-computing device 102 includes a mobile device such as a mobile telephone, a smartphone, a PDA, a tablet, or a laptop. Additionally or alternatively, the client-computing device 102 may include a non-mobile device such as a desktop, a server, or another type of computing device. Additional details with respect to the client-computing device 102 are discussed below with respect to FIG. 6.

In at least one embodiment, the merchant-computing device 106 is a computing device that provides retail support to the merchant and communicates with the payment processing system 114. For example, the merchant-computing device 106 can include functionality required to read credit card information, scan bar codes, provide readouts of receipt information, and so forth. In one embodiment, the merchant-computing device 106 is a computing device at a physical POS, utilized by an employee of the merchant for the purpose of “ringing up” a customer who wishes to purchase one or more items. In that embodiment, the merchant-computing device 106 may include a display and one or more input devices (e.g., a keyboard, a bar code scanner, etc.) with which the merchant's employee interacts. Additionally, the merchant-computing device 106 may include an additional peripheral with which a customer may interact (e.g., a touch screen device where the customer can see a total, authorize a credit card transaction, etc.). In at least one embodiment, as shown in FIG. 1, the payment processing system application 116 includes the functionality required to communicate purchase transaction information (e.g., a credit card number, merchandise information, merchant information, transaction notifications, etc.) to the payment processing system 114.

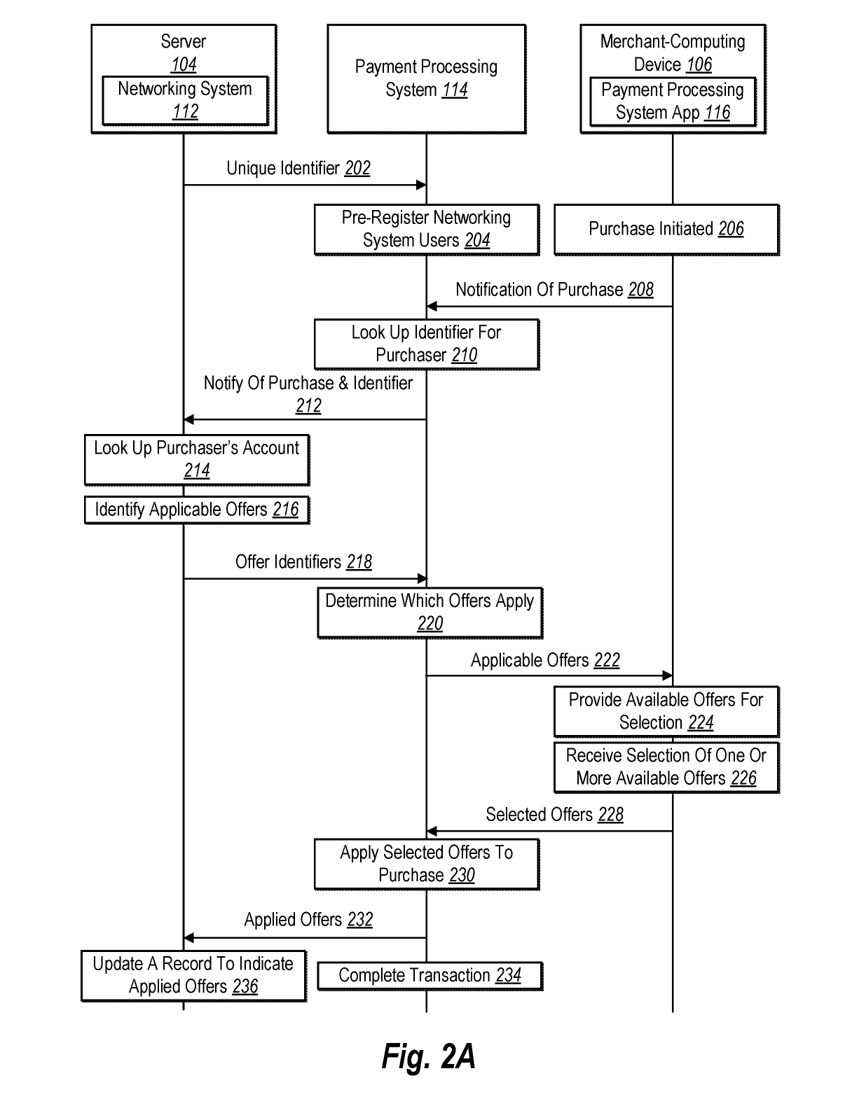

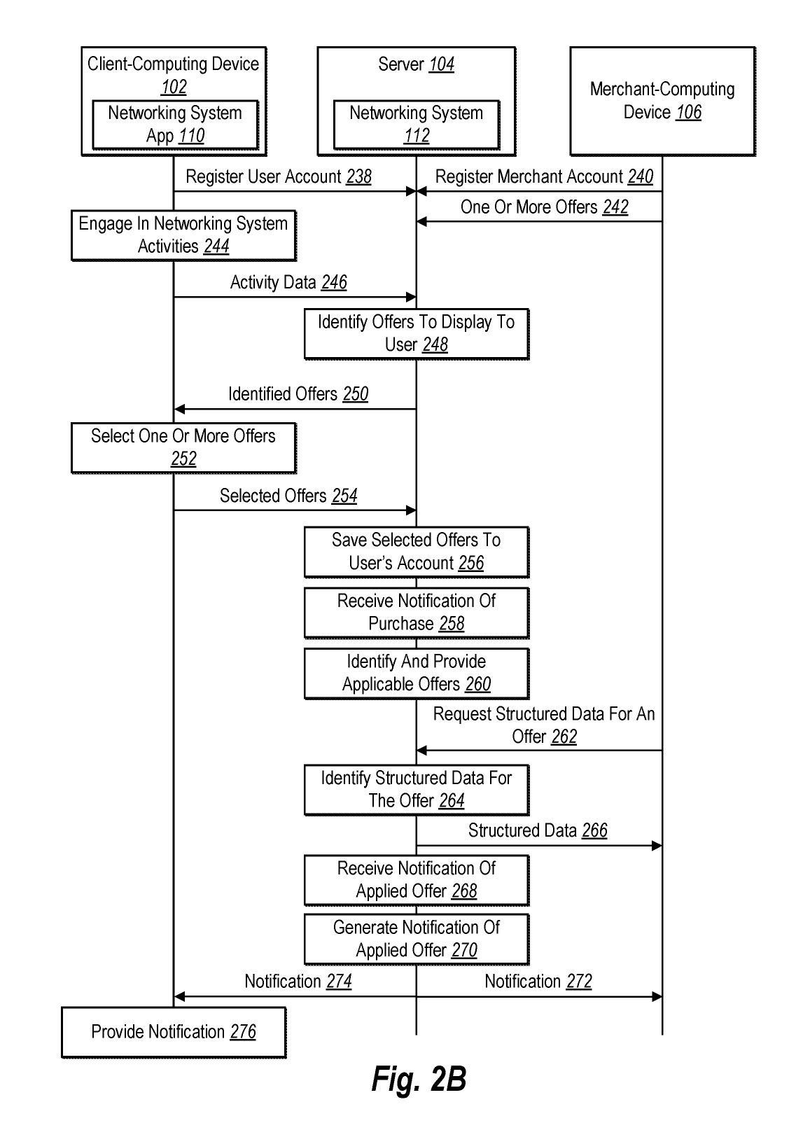

As discussed above, the systems and methods laid out with reference to FIG. 1 facilitate use of offers available via a networking system in offline purchases. FIGS. 2A and 2B illustrate example process diagrams of one or more example embodiments of processes implemented by the offer management system 100 discussed above. Consistent with the offer management system 100 illustrated in FIG. 1, FIGS. 2A and 2B illustrate the networking system 112 facilitating use of an offer by a networking system user at a point of sale associated with the merchant.

As shown in FIG. 2A, in one or more embodiments, the process begins with the networking system 112 providing a unique identifier (202) to the payment processing system 114 such that the payment processing system 114 can pre-register the networking system users (204). For example, in at least one embodiment, the networking system 112 provides a unique identifier (202) including users' networking system unique identifiers, users' names, users' phone numbers, users' addresses, and so forth. In one or more embodiments, the unique identifier may be a hash of a user identifier used by the networking system 112. Additionally, in at least one embodiment, the networking system 112 provides the unique identifier (202) subject to the user's privacy settings. For example, the offer management system 100 may only provide a user's unique identifier after the user opts in to the services provided by the offer management system 100. Thus, the offer management system 100 protects the user's data privacy.

Referring again to FIG. 2A, the payment processing system 114 then pre-registers the networking system users (204) by linking existing payment processing system accounts to the user information provided by the networking system 112. For example, in one embodiment, the payment processing system 114 utilizes a unique identifier (e.g., a phone number) to link a user's payment processing system account to his networking system account. Accordingly, as a result of the pre-registration process (204), the payment processing system 114 can link a networking system unique identifier to a payment processing system account for each networking system user who has an account with the payment processing system 114.

At some point following the pre-registration process (204), a purchase is initiated (206) on the merchant-computing device 106. For example, in at least one embodiment, a purchase is initiated (206) when a user swipes a credit card at the merchant-computing device 106. In other embodiments, the purchase may be initiated (206) when the user enters a phone number at the merchant-computing device 106, or swipes a loyalty membership card at the merchant-computing device 106, or the like.

In response to the initiation of the purchase (206), the payment processing system application 116 provides a notification of the purchase (208) to the payment processing system 114. In one or more embodiments, the notification of purchase (208) can be a token including information related to the purchase. For example, the notification can include a merchant identifier (e.g., a unique code specific to the merchant), a purchaser identifier (e.g., the user's phone number, email address, etc.), payment information (e.g., a credit card number, a debit card number, etc.), and purchase information (e.g., items being purchased, a total amount for the purchase, etc.).

Using the notification of purchase (208), the payment processing system 114 next looks up a networking system identifier associated with the purchaser (210). As described above, during the pre-registration process (204), the payment processing system 114 links a unique identifier for a networking system user to the networking system user's account with the payment processing system 114. Accordingly, in at least one embodiment, the payment processing system 114 looks up the unique identifier for the purchaser (210) by first identifying the payment processing system account for the purchaser (e.g., based on the purchaser's payment information), and identifying the purchaser's networking system unique identifier associated with the purchaser's account.

With the purchaser's unique identifier identified (210), the payment processing system 114 provides the unique identifier to the networking system 112 along with a notification of the purchase (212). For example, the payment processing system 114 can include information in the notification (212) that includes the merchant identifier and other purchase information.

In at least one embodiment, the networking system 112 utilizes the provided information to lookup the purchaser's networking system user account (214) and identify offers that are applicable to the purchase (216). For example, the networking system 112 looks up the purchaser's networking system user account utilizing the networking system unique identifier provided by the payment processing system 114. In one or more embodiments, the purchaser has previously viewed and selected a variety of offers available via the networking system 112. Accordingly, at this point, the networking system 112 has saved the purchaser's selected offers to the networking system user account associated with the purchaser.

Thus, in one or more embodiments, the networking system 112 identifies applicable offers (216) by identifying one or more offers saved to the purchaser's networking system user account that are associated with the merchant. For example, each offer saved to the purchaser's networking system user account includes information including a merchant identifier, redemption information (e.g., an amount to be removed from the cost of an item), and expiration information (e.g., a date by which the offer must be used, a number of times the offer may be used, etc.). To illustrate, if the purchaser is purchasing a pair of jeans from merchant “XYZ,” the networking system 112 identifies applicable offers (216) by identifying offers saved to the purchaser's networking system user account that are associated with merchant “XYZ” and still capable of being redeemed (e.g., not expired).

Furthermore, in at least one embodiment, the notification provided (212) by the payment processing system 114 can also include information detailing the retail items included in the purchase. In that case, the networking system 112 can further identify applicable offers (216) saved to the purchaser's networking system user account that are associated with the retail items included in the purchase. As with the example articulated above, if the purchaser is purchasing a pair of jeans from merchant “XYZ,” the networking system 112 identifies applicable offers (216) by identifying offers saved to the purchaser's networking system user account that are associated with merchant “XYZ,” and are further associated with jeans.

In response to identifying one or more offers (216) that are applicable to the initiated purchase, the networking system 112 provides a unique identifier for each offer (218) to the payment processing system 114. In one or more embodiments, when a merchant registers an offer with the networking system 112, the networking system 112 provides the offer information to the payment processing system 114. For example, in at least one embodiment, the payment processing system 114 maintains a listing of offer identifiers, and the payment information associated with each offer identifier (e.g., subtract 5% from the cost of a pizza, subtract 50% from the cost of the second pair of shoes, etc.).

In at least one embodiment, the payment processing system 114 can further determine which offers apply (220) to the purchase. For example, in the event that the payment processing system 114 only provides the purchaser's networking system account identifier and the merchant's identifier to the networking system 112, the networking system 112 may only be able to identify offers saved to the purchaser's account that are applicable to the merchant. Because the payment processing system 114 has additional information related to the retail items being purchased, the payment processing system 114 can further identify a subset of offers provided by the networking system 112 that are specific to the retail items being purchased from the merchant. For example, if the purchaser is attempting to purchase jeans from merchant “XYZ,” the networking system 112 may identify and provide offer identifiers for saved offers for t-shirts from merchant “XYZ,” hats from merchant “XYZ,” and jeans from merchant “XYZ.” Accordingly, payment processing system 114 can utilize the purchase information provided by the payment processing system application 116 to determine that only the offer for jeans from merchant “XYZ” apply to the present purchase.

In at least one embodiment, the payment processing system 114 can apply one or more offers to the purchase transaction upon determining which offers are applicable (220). For example, in response to determining that the offer for jeans from merchant “XYZ” is applicable to the purchaser's transaction, the payment processing system 114 may simply apply the offer to the transaction, and continue processing the purchase as normal. In that case, the purchaser may not be aware that the payment processing system 114 applied the offer until the networking system 112 provides a notification to the purchaser regarding the use, or until the purchaser logs into the networking system 112 to discover the offer is no longer available.

Alternatively, as shown in FIG. 2A, the payment processing system 114 can provide the applicable offers (222) to the merchant-computing device 106 via the payment processing system application 116. For example, the payment processing system 114 can provide the offer identifiers for the applicable offers (222) to the merchant-computing device 106. The merchant-computing device 106 can then provide the available offers for selection (224). For example, the merchant-computing device 106 can provide a display that includes information associated with each available offer, and the purchaser can select one or more of the available offers in the display.

In response to receiving a selection of one or more available offers (226) at the merchant-computing device 106, the payment processing system application 116 communicates the selected offers (228) back to the payment processing system 114. At that point, the payment processing system 114 can apply the selected offers to the purchase (230) and complete the transaction (234).

Additionally, after applying the selected offers to the purchase (230), the payment processing system 114 can notify the networking system 112 regarding the applied offers (232). In one or more embodiments, in response to being notified regarding the applied offers (232), the networking system 112 updates a record to indicate the applied offers (236). For example, in one embodiment, the networking system 112 updates a record to indicate the applied offers (236) by updating offer information saved in association with the purchaser's networking system user account in accordance with the offer's redemption information. For instance, if the offer is a “one-time use only” offer, the networking system 112 can update the purchaser's account such that the offer is no longer available for use. If the offer is a punch-card type offer, the networking system 112 can update the purchaser's account to add one to the previous number of uses associated with the offer. Furthermore, in at least one embodiment, the networking system 112 updates the record to indicate the applied offers (236) by identifying additional offers available via the networking system 112 that are related to the applied offer and associating those additional offers with the purchaser's networking system account.

In another example, the networking system 112 updates a record to indicate the applied offers (236) by updating offer information saved in association with the merchant's networking system user account. For example, in at least one embodiment, the networking system 112 generates an offer report detailing various insights related to each offer promoted by the merchant via the networking system. For instance, in response to an offer being applied to a purchase, the networking system 112 can generate an offer report that details information including a conversion rate for the offer (e.g., the number of users who save the offer via the networking system 112 versus the number of users who actually apply the saved offer to a purchase), an offer redemption count (e.g., the number of instances of the offer available via the networking system versus the number of instances of the offer that have been redeemed), demographic information associated with networking system users who have applied the offer to a purchase, and so forth. The networking system 112 can generate the offer report including information for a particular offer promoted by the merchant via the networking system 112, or for all offers promoted by the merchant via the networking system 112. Furthermore, the networking system 112 can generate the offer report on a schedule (e.g., hourly, daily, weekly, etc.), or on request by the merchant.

FIG. 2B further illustrates the purchase process. For example, as mentioned above, at some point prior to making a purchase, a user of client-computing device 102 registers a networking system user account (238). In one or more embodiments, the user of the client-computing device 102 registers for a user account by providing information to the networking system 112 via one or more interactive graphical user interfaces presented by the networking system application 110. The information provided by the user of the client-computing device 102 can include, but is not limited to, name, address, occupation, relationship status, education, and other demographic information. In at least one embodiment, after the user of the client-computing device 102 engages in networking system activities (244) (e.g., clicking posts, liking posts, commenting on posts, scrolling through a newsfeed, messaging a friend, etc.), the networking system application 110 reports the user's activity data (246) to the networking system 112, subject to the user's privacy settings.

Further illustrated in FIG. 2B, at some point prior to promoting one or more offers via the networking system 112, the merchant registers a merchant account (240) with the networking system 112. As discussed above, the merchant registers for an account with the networking system 112 so as to provide offers to networking system users. Accordingly, in at least one embodiment, the merchant registers for a merchant account with the networking system 112 by providing information to the networking system 112. The merchant's account information can include, but is not limited to, a unique identifier for the merchant, inventory information (e.g., categories of merchandise, amounts of various types of products, inventory locations, etc.), price information (e.g., cost per unit for the products in the merchant's inventory), POS information (e.g., locations of each POS, hours of business for each POS, etc.), and so forth.

In at least one embodiment, the merchant can provide this information to the networking system 112 by entering the information into one or more interactive graphical user interfaces. Alternatively, the merchant can provide this information in a batch upload via a spreadsheet, comma separated file, or so forth. In response to receiving the merchant's account information, the networking system 112 can generate an account for the merchant.

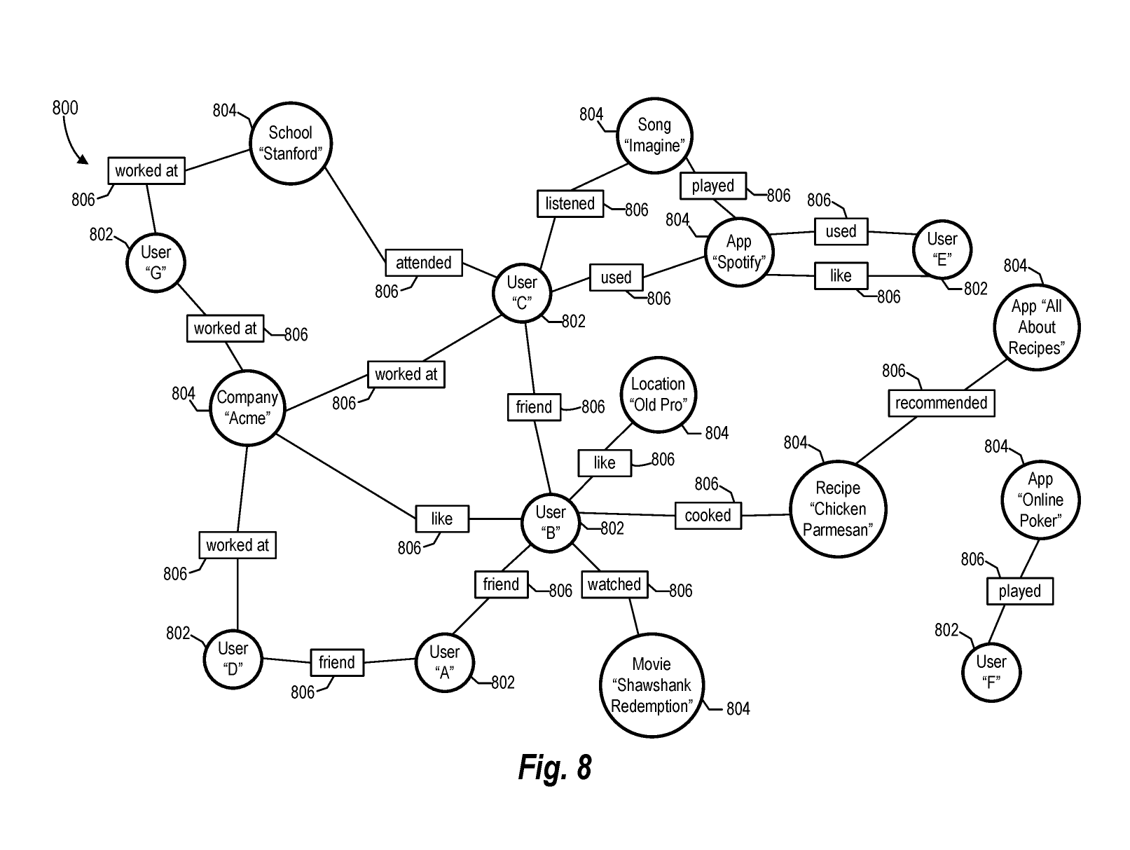

Furthermore, as part of the registration process for the merchant, the merchant can configure one or more offers (242) for the networking system 112 to provide to networking system users. For example, in order to configure an offer the merchant can provide information including, but not limited to, the terms of the offer (e.g., one or more products related to the offer, the expiration date of the offer, geographic restrains associated with the offer, etc.), a maximum number of networking system users to whom the networking system 112 should provide the offer, a maximum number of times the offer can be redeemed, preferred user demographic information describing networking system users to whom the networking system 112 should provide the offer, and so forth. In response to receiving this information, the networking system 112 can generate an offer object containing the offer information, which is subsequently stored in the social graph described in more detail below with reference to FIG. 8. The process by which the merchant can create one or more offers via the networking system 112 is discussed in further detail in U.S. patent application Ser. No. 15/340,736, filed 1 Nov. 2016 (PROVIDING INTERACTIVE ELEMENTS WITH A LIVE VIDEO PRESENTATION), and U.S. patent application Ser. No. 15/370,760, filed 6 Dec. 2016 (IDENTIFYING AND CUSTOMIZING DISCOVERY OF OFFERS BASED ON SOCIAL NETWORKING SYSTEM INFORMATION), both of which are incorporated herein by reference in their entireties.

After receiving activity data (246) associated with the user of the client-computing device 102 and after the merchant has configured one or more offers, the networking system identifies offers to provide and display to the user (248). For example, by analyzing the user's networking system activity data (246), the networking system 112 can determine various characteristics that apply to the user. The networking system 112 can then identify one or more offers that apply to those determined characteristics. For example, the user's networking system activity data may indicate that the user is female, is age 25-30 years old, lives in a west-coast urban location, and works full-time. Accordingly, the networking system 112 can identify offers to display to the user (248) that are applicable to those determined characteristics (e.g., offers from merchants located in larger west-coast cities, offers for women's products, etc.). In at least one embodiment, the networking system 112 identifies offers that are applicable to determined characteristics by matching the determined characteristics to data associated with each identified offer (e.g., demographic information associated with an offer, geographic information associated with an offer, etc.).

As illustrated in FIG. 2B, the networking system 112 provides the identified offers (250) to the networking system application 110, where the provided offers are displayed to the user of the client-computing device 102. For example, the networking system 112, via the networking system application 110, can provide the identified offers (250) in the user's networking system newsfeed and/or in the display framework of a networking system GUI (e.g., in a banner advertisement, in a side display, etc.).

The user of the client-computing device 102 can then encounter and select one or more offers (252) displayed via the networking system application 110. In one or more embodiments, the user of the client-computing device 102 selects one or more offers (252) by clicking on an offer displayed by the networking system application 110 and viewing the contents of the offer and/or saving the offer for later. In response to the user clicking on an offer in order to save the offer for later, the networking system application 110 communicates the selected offers (254) to the networking system 112, where the networking system 112 saves the selected offers to the user's networking system user account (256). For example, the networking system 112 adds the selected offer to a list of saved offers associated with the user of the client-computing device 102.

At some point after the user of the client-computing device 102 has saved one or more offers available via the networking system 112, the user may visit a physical point of sale associated with the merchant in order to purchase one or more retail items. As described above with reference to FIG. 2A, the purchase is initiated (206) when the user swipes a credit card at the merchant-computing device 106. At that point, the payment processing system application 116 provides a purchase notification (208) to the payment processing system 114, and the payment processing system 114 interfaces with the networking system 112 to identify and apply one or more offers to the purchase. For example, the networking system 112 receives a notification of the purchase (258) from the payment processing system 114 (not shown in FIG. 2B) and identifies and provides applicable offers (260) to the payment processing system 114 as part of the procedure described with relation to FIG. 2A.

As mentioned above, in at least one embodiment, the payment processing system 114 can provide identifiers of one or more applicable offers to the merchant-computing device 106 in order for the user to select at least one offer to apply to the purchase. Accordingly, in order to display text and images associated with the offer that will be recognizable to the user, the merchant-computing device 106 may request structured data associated with an offer (262) from the networking system 112. For example, the networking system displays an offer including specific text and images. When deciding, at a merchant's point of sale, whether to apply that offer to a purchase, it can assist the user if the same specific text and images are displayed on the merchant-computing device 106.

Accordingly, the merchant-computing device 106 can request this structured data for the offer (262) from the networking system 112. The request can include the offer's unique identifier such that the networking system 112 can identify the structured data for the offer (264) and provide the structured data (266) to the merchant-computing device 106.

Further described above with reference to FIG. 2A, after the payment processing system 114 applies an offer to a purchase transaction, the payment processing system sends a notification of the applied offer to the networking system 112. In response to receiving the notification of the applied offer (268) from the payment processing system 114 (not shown in FIG. 2B), the networking system 112 can generate a networking system notification regarding the applied offer (270). For example, the notification can include structured data associated with the offer (e.g., the offer identifier, the offer's descriptive text, digital media associated with the offer, redemption information, the user's demographic information, etc.).

The networking system 112 can then provide the generated notification (272) to the merchant-computing device 106. For example, the networking system 112 can provide a notification (272) to the merchant-computing device 106 that includes a report regarding the offer (e.g., the offer report discussed above with regard to FIG. 2A). Additionally or alternatively, the notification (272) provided to the merchant-computing device 106 may simply include a message that the offer was successfully applied to the purchase transaction.

Further shown in FIG. 2B, the networking system 112 can provide the notification (274) to the client-computing device 102 where the networking system application 110 displays the notification (276) to the user. For example, the notification (274) can include a message that the offer was successfully applied to the purchase transaction along with a statement regarding the redemption information associated with the offer. For example, if the offer is a “one-time use only” offer, the notification (274) can include a statement informing the user that the offer can no longer be used. If the offer is a punch-card type offer, the notification (274) can include a statement informing the user regarding a number of uses left for the offer (e.g., “Just 3 more coffees until your free coffee!”).

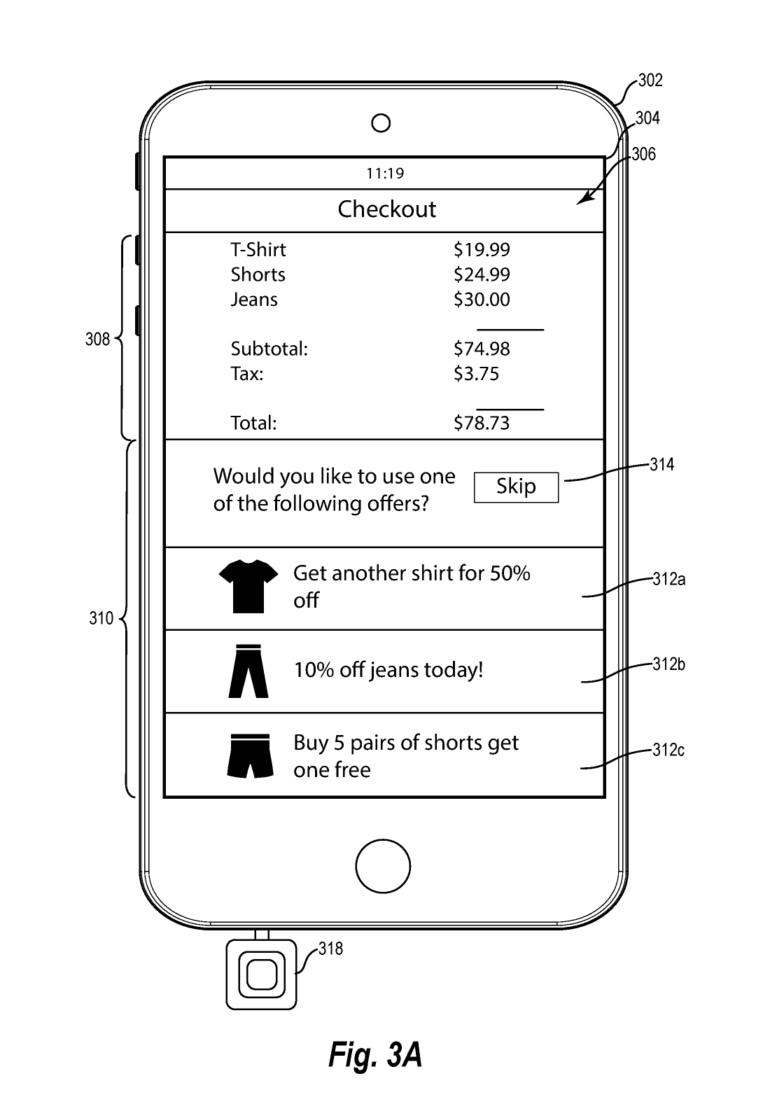

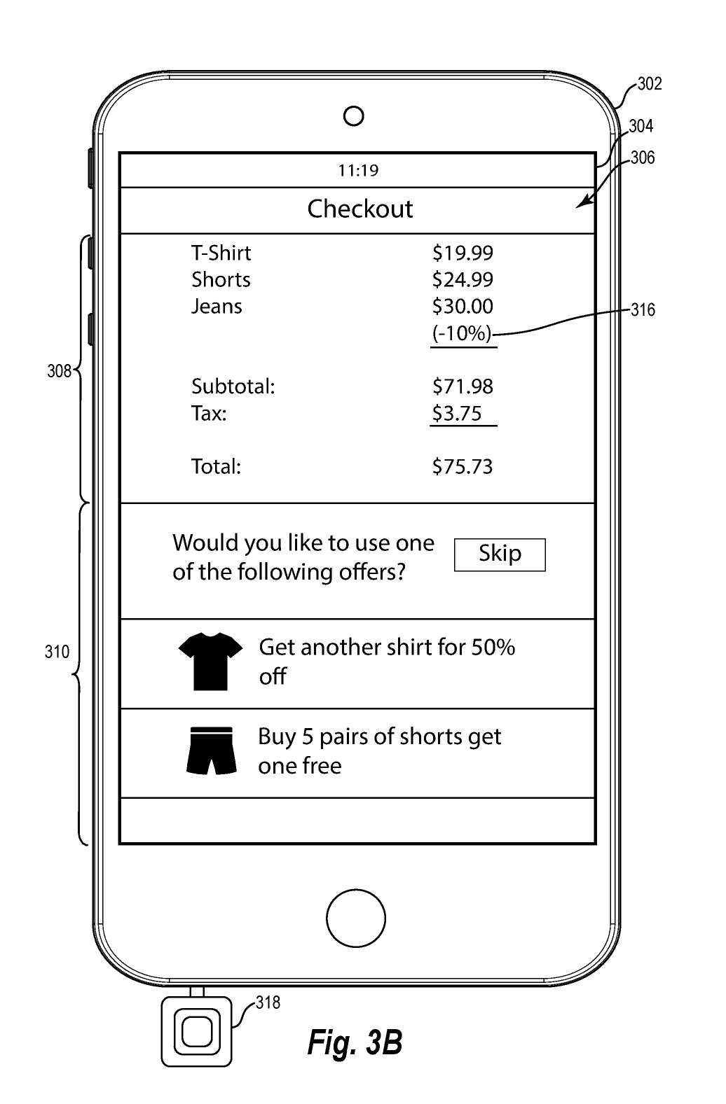

As will be described in more detail below, the components of the offer management system 100 can include, along and/or in combination with the other components, one or more graphical user interfaces (“GUIs”). In particular, as described above, in response to receiving a request for structured offer information from the merchant-computing device 106, the networking system 112 can provide text and media to the merchant-computing device 106 such that the merchant-computing device 106 can display offer information. FIGS. 3A and 3B and the description that follows illustrate various example embodiments of the GUIs and features that are in accordance with general principles as described above.

For example, as described above, the merchant-computing device 106 can provide GUIs including structured offer information provided by the networking system 112 for offers that apply to a purchase transaction. To illustrate, a merchant-computing device 302 (e.g., as an example of the merchant-computing device 106) associated with the merchant is illustrated in FIG. 3A. In at least one embodiment, the merchant-computing device 302 includes a touch screen display 304 displaying an interactive purchase transaction GUI 306.

As shown in FIG. 3A, the interactive purchase transaction GUI 306 includes a purchase summary 308 and an offer display 310. In one or more embodiments, the purchase summary 308 includes a listing of items to be purchased, the item prices, a subtotal, a tax total, and an overall total. As shown, the information in the purchase summary 308 is related to a physical purchase that a networking system user (e.g., the user of the client-computing device 102) has initiated at a merchant's point of sale.

As discussed above, in at least one embodiment, a purchase is initiated when the user swipes a payment card. For example, in response to the user swiping a payment card though the card reader 318, the merchant-computing device 302 can notify the payment processing system 114 of the initiated purchase. As discussed above, the notification can include the user's payment information, a merchant identifier, and the purchase information (e.g., shown in the purchase summary 308). The payment processing system 114 then interfaces with the networking system 112 to identify offers available via the networking system 112 that are applicable to the purchase.

As shown in FIG. 3A, the offer display 310 includes offers 312a-312c including text and media provided by the networking system 112 in response to a request from the merchant-computing device 302. For example, as discussed above, at this point in the purchase transaction, the user has swiped a payment card and the payment processing system 114 has interfaced with the networking system 112 to provide one or more indications (e.g., offer identifiers) of offers that are available to apply to the purchase to the merchant-computing device 302. Accordingly, the merchant-computing device 302 can request structured data associated with the one or more offer identifiers from the networking system 112. In response to receiving the structured data associated with the one or more offer identifiers, the merchant-computing device 302 can generate and display the offers 312a-312c.

In one or more embodiments, each of the offers 312a-312c is interactive and can be selected via a touch gesture. For example, in response to a user selecting one of the offers 312a-312c, the merchant-computing device 302 communicates the offer selection to the payment processing system 114. The payment processing system 114 then applies the selected offer to the purchase.

Additionally illustrated in FIG. 3A, the offer display 310 also includes a skip button 314. In response to the purchaser selecting the skip button 314, the merchant-computing device 302 can remove the offer display 310 from the purchase transaction GUI 306. In at least one embodiment, in response to the user selecting the skip button 314, the payment processing system 114 can continue to process the purchase transaction according to the information shown in the purchase summary 308.

As mentioned above, in response to the purchaser selecting one or more of the displayed offers 312a-312c, the merchant-computing device 302 provides the selected offer identifier to the payment processing system 114 for application to the purchase transaction. For example, as shown in FIG. 3B, in response to the user selecting the offer object 312b, the payment processing system 114 applies the offer to the purchase transaction and notifies the merchant-computing device 302 regarding the application of the offer. In response to receiving the notification from the payment processing system 114, the merchant-computing device 302 then updates the purchase summary 308 with offer application indicator 316. As shown, the offer application indicator 316 indicates that 10% of the cost of the pair of jean has been deducted from the purchase.

Although the information described with regard to the offer display 310 in FIGS. 3A and 3B is presented on a merchant computing device, in additional embodiments, the offer management system 100 can provide offer information on a client computing device (e.g., client computing device 102) associated with the user making the purchase. For example, in one embodiment and in order to notify the user of offers that apply to an initiated transaction, in response to an initiated purchase the offer management system 100 provides a notification of available offers via the networking system application on the user's client device. The offer management system 100 can provide the notification of applicable offers in an alert, pop-up window, direct message, or via any other notification method. After providing the notification to the client device, the offer management system 100 can receive information back from the client device regarding a selection of one or more offers to apply to the purchase. The offer management system 100 can then send this information to the merchant (e.g., via the payment processor) to apply to the user's purchase at the POS.

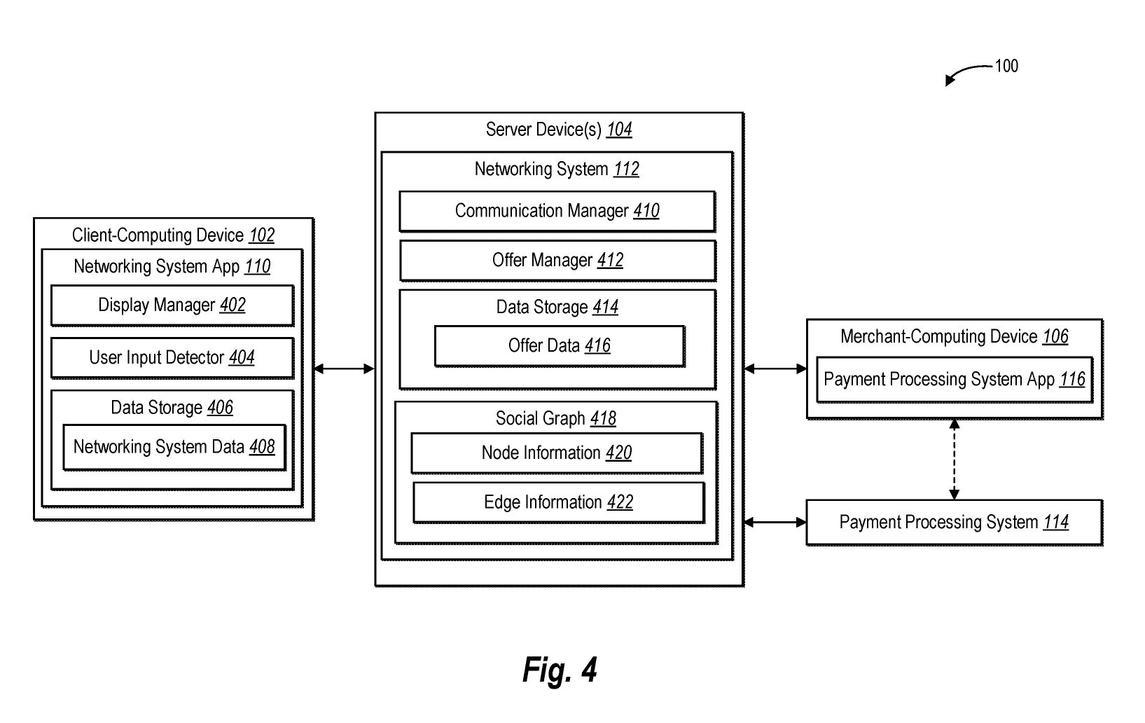

FIG. 4 illustrates a schematic diagram illustrating an example embodiment of the offer management system 100. As shown in FIG. 4, the offer management system 100 includes various components for performing the processes and features described herein. For example, as shown in FIG. 4, the offer management system 100 includes but is not limited to, the client-computing device 102, the merchant-computing device 106, the payment processing system 114, and the server 104. In one or more embodiments, the client-computing device 102 includes a networking system application 110, which includes a display manager 402, a user input detector 404, and a data storage 406 including networking system data 408. Additionally, the server 104 hosts the networking system 112. In one or more embodiments, the networking system 112 includes a communication manager 410, an offer engine 412, and data storage 414 including offer data 416.

In at least one embodiment, the offer management system accesses the networking system 112 in order to identify and analyze networking system user data. Accordingly, the networking system 112 includes a social graph 418 for representing a plurality of users, actions, and concepts. In one or more embodiments, the social graph 418 includes node information 420 and edge information 422. Node information 420 of the social graph 418 stores information including, for example, nodes for users and nodes for repositories. Edge information 422 of the social graph 418 stores information including relationships between nodes and/or actions occurring within the networking system 112. Further details regarding the networking system 112, the social graph 418, edges, and nodes is presented below with respect to FIG. 8.

Each of the components 402 through 406 of the networking system application 110, and the components 410-422 of the networking system 112 can be implemented using a computing device including at least one processor executing instructions that cause the offer management system 100 to perform the processes described herein. In some embodiments, the networking system components described herein can be implemented by the server 104, or across multiple server devices. Additionally or alternatively a combination of one or more server devices and one or more client devices can implement the components of the networking system application 110. Additionally or alternatively, the components described herein can comprise a combination of computer-executable instructions and hardware.

In one or more embodiments, the networking system application 110 is a native application installed on the client-computing device 102 and the merchant-computing device 106, respectively. For example, the networking system application 110 can be a mobile application that installs and runs on a mobile device, such as a smart phone or a tablet computer. Alternatively, the networking system application 110 can be a desktop application, widget, or other form of a native computer program. Furthermore, the networking system application 110 may be a remote application accessed by the client-computing device 102. For example, the networking system application 110 may be a web application that is executed within a web browser of the client-computing device 102.

As mentioned above, and as shown in FIG. 4, the networking system application 110a includes a display manager 402. The display manager 402 provides, manages, and/or controls a graphical user interface that allows a networking system user to interact with features of the networking system 112. For example, the display manager 402 provides a graphical user interface that facilitates the display of the networking system user's newsfeed.

More specifically, the display manager 402 facilitates the display of a graphical user interface. For example, the display manager 402 may compose the graphical user interface of a plurality of graphical components, objects, and/or elements that allow a user to engage in networking system activities. More particularly, the display manager 402 may direct the client-computing device 102 to display a group of graphical components, objects, and/or elements that enable a user to interact with various features of the networking system 112.

In addition, the display manager 402 directs the client-computing device 102 to display one or more graphical objects, controls, or elements that facilitate user input for interacting with various features of the networking system 112. To illustrate, the display manager 402 provides a graphical user interface that allows the user of the client-computing device 102 to input one or more types of content into a networking system post or electronic message.

The display manager 402 also facilitates the input of text or other data for the purpose of interacting with one or more features of the networking system 112. For example, the display manager 402 provides a user interface that includes a touch display keyboard. A user can interact with the touch display keyboard using one or more touch gestures to input text to be included in a networking system post or electronic message. For example, a user can use the touch display keyboard to compose a message. In addition to text, the graphical user interface including the touch display keyboard can facilitate the input of various other characters, symbols, icons, or other information.

Furthermore, the display manager 402 is capable of transitioning between two or more graphical user interfaces. For example, in one embodiment, the display manager 402 provides a newsfeed to a user of the client-computing device 102 containing one or more networking system posts from co-users along with various offers provided by the networking system 112. Later, in response to detected input from the user of the client-computing device 102 in connection with a particular displayed offer, the display manager 402 transitions to a second graphical user interfaces that includes additional details related to the displayed offer.

As further illustrated in FIG. 4, the networking system application 110 includes a user input detector 404. In one or more embodiments, the user input detector 404 detects, receives, and/or facilitates user input in any suitable manner. In some examples, the user input detector 404 detects one or more user interactions with respect to the user interface. As referred to herein, a “user interaction” means a single interaction, or combination of interactions, received from a user by way of one or more input devices.

For example, the user input detector 404 detects a user interaction from a keyboard, mouse, touch page, touch screen, and/or any other input device. In the event the client-computing device 102 includes a touch screen, the user input detector 404 detects one or more touch gestures (e.g., swipe gestures, tap gestures, pinch gestures, reverse pinch gestures) from a user that forms a user interaction. In some examples, a user can provide the touch gestures in relation to and/or directed at one or more graphical objects or graphical elements of a user interface.

The user input detector 404 may additionally, or alternatively, receive data representative of a user interaction. For example, the user input detector 404 may receive one or more user configurable parameters from a user, one or more commands from the user, and/or any other suitable user input. The user input detector 404 may receive input data from one or more components of the networking system 112, or from one or more remote locations.

The networking system application 110 performs one or more functions in response to the user input detector 404 detecting user input and/or receiving other data. Generally, a user can control, navigate within, and otherwise use the networking system application 110 by providing one or more user inputs that the user input detector 404 can detect. For example, in response to the user input detector 404 detecting user input, one or more components of the networking system application 110 allow the user of the client-computing device 102 to scroll through a newsfeed.

As shown in FIG. 4, and as mentioned above, the networking system application 110 also includes the data storage 406. The data storage 406 includes networking system data 408. In one or more embodiments, the networking system data 408 is representative of networking system data information, such as described herein.

Also as shown in FIG. 4, and as mentioned above, the server 104 hosts the networking system 112. The networking system 112 provides networking system posts, electronic messages, offers, and so forth to one or more users of the networking system 112 (e.g., by way of a profile, a newsfeed, a communication thread, a timeline, a “wall”, or any other type of graphical user interface). For example, one or more embodiments provide a user with a networking system newsfeed containing posts from one or more co-users associated with the user, as well as offers and other advertisements.

In one or more embodiments, a networking system user scrolls through the networking system newsfeed in order to view recent networking system posts submitted by the one or more co-users associated with the user via the networking system 112. In one embodiment, the networking system 112 organizes the networking system posts chronologically in a user's networking system newsfeed. In alternative embodiments, the networking system 112 organizes the networking system posts geographically, by interest groups, according to a relationship coefficient between the user and the co-user, etc. Additionally, in one or more embodiments, the user can download a copy of the networking system newsfeed as a record of the networking system posts displayed thereon.

The networking system 112 also enables the user to engage in all other types of networking system activity. For example, the networking system 112 enables a networking system user to scroll through newsfeeds, click on posts and hyperlinks, view and save offers, compose and submit electronic messages and posts, interact with structured objects, and so forth. As used herein, a “structured object” is a displayed communication (e.g., an offer, a post, etc.) that includes structured data.

In one or more embodiments, “structured data” can include any data that is structured into specific groups, fields, or categories, and/or is associated with particular aspects of an offer. For example, structured data can include metadata associated with node and edge information related to an offer, information related to the offer's author, information related to a particular item featured in the offer, and interaction information related to the offer within the networking system 112. To illustrate, structured data for an offer can include formatting information, the offer author's name and location, textual content of the offer, terms of the offer, expiration information related to the offer, or any other specific types of information/data associated with the offer. The structured data may also include various multimedia content such as images (e.g., digital pictures, digital map images), digital video, digital audio, etc. Using this structured data, the networking system 112 can facilitate the insertion of structured objects within a newsfeed, a listing, or elsewhere. Furthermore, as described above, the networking system 112 can provide the structured data to the merchant-computing device 106 for display to the user at the merchant's point of sale.

As shown in FIG. 4, and as mentioned above, the networking system 112 handles all activities related to offers available via the networking system 112. For example, the networking system 112 handles the registration process by which a merchant makes one or more offers available via the networking system 112. To illustrate, the merchant registration process includes the merchant providing offer information to the networking system 112. In one or more embodiments, the offer information includes an offer title, an offer description, expiration terms (e.g., the offer expires on a particular date or the offer expires after a given number of uses), digital media related to the offer (e.g., digital photographs, digital video, etc.), formatting information (e.g., font selections, text size, text placement, etc.), audience targeting information (e.g., demographics for networking system users to whom the merchant would like the offer presented), and so forth. In at least one embodiment, the networking system 112 receives offer information from the merchant in response to the merchant entering the offer information via one or more graphical user interfaces presented by the networking system 112 on the merchant-computing device 106.

As mentioned above, in response to receiving the offer information from the merchant, the networking system 112 also generates offer objects. In one or more embodiments, an offer object is a structured object that includes all the structured data associated with an offer. Once a structured object is created for a particular offer, the networking system 112 stores the offer object in the social graph and identifies an audience of networking system users who match the audience targeting information specified by the merchant. In one or more embodiments, the networking system 112 then displays the offer object to the identified audience of networking system users.

Also as illustrated in FIG. 4, the networking system 112 includes a communication manager 410. In one or more embodiments, the communication manager 410 sends and receives communications to and from the networking system application 110, the merchant-computing device 106, and the payment processing system 114. For example, the communication manager 410 receives information (subject to the user's privacy settings) associated with networking system activities engaged in by one or more networking system users. To illustrate, the communication manager 410 receives information from the networking system application 110 detailing the clicks, scrolls, keyboard inputs, hovers, and so forth engaged in by the user of the client-computing device 102 in association with one or more graphical user interfaces of the networking system 112. In at least one embodiment, the networking system 112 utilizes this information to identify one or more characteristics of the user of the client-computing device 102, as will be described in more detail below.

Furthermore, the communication manager 410 also receives information associated with a user's selection of an offer made available via the networking system 112. For example, as described above, the user of the client-computing device 102 can interact with one or more offers presented by the networking system 112 via the networking system application 110. Accordingly, when the user selects an offer to save to his or her networking system account, the communication manager 410 receives an indication of the selected offer and associates the offer object with the user's networking system account. In this way, the user can build up a repository of stored offers for later use. In one or more embodiments, the communication manager 410 receives information associated with the user's selection of an offer only when the user has opted into the services provided by the offer management system 100. For instance, in at least one embodiment, the offer management system 100 provides a selectable option wherein the user can indicate a desire to interact with the offer management system 100. Furthermore, any information transmitted, exchanged, and/or utilized by the offer management system 100 may be subject to privacy settings associated with the corresponding users. As such, the users retain control of the privacy of their information and the offer management system 100 does not user any user information in a way that contradicts the preferences and/or privacy settings provided by the user.

Moreover, the communication manager 410 receives information associated with a purchase transaction from the payment processing system 114. For example, in at least one embodiment, the communication manager can receive notifications from the payment processing system 114 including purchase information such as, but not limited to, including payment information (e.g., from a credit card or debit card), purchaser information (e.g., the purchaser's name, the purchaser's networking system unique identifier, or other identifier), merchant information (e.g., the merchant's identifier) information about the items being purchased, time and date information, and point of sale information (e.g., the location of the point of sale, etc.).

The communication manager 410 can also receive information from the merchant-computing device 106. For example, the communication manager 410 can receive a request from the merchant-computing device 106 for structured data associated with an applicable offer, as described above with reference to FIGS. 3A and 3B.

As mentioned above, and as illustrated in FIG. 4, the networking system 112 also includes the offer engine 412. In one or more embodiments, the offer engine 412 manages offers saved by users of the networking system 112. For example, as mentioned above, a networking system user can interact with and save one or more offers presented by the networking system 112. Accordingly, the offer engine 412 manages the user's saved offers by associating each saved offer object with the user's networking system information such that the user can later access a listing of all saved offer objects.

Additionally, the offer engine 412 also manages the user's saved offer objects by determining whether a saved offer is still valid. For example, as mentioned above, each offer object available via the networking system 112 includes expiration information. Thus, in one or more embodiments, the offer engine 412 periodically analyzes the expiration information of each offer object saved by the user to determine whether the offer's terms of expiration have been met. To illustrate, an offer's terms of expiration are met when the current date is past the date of expiration outlined by the offer's terms of expiration. In another example, an offer's terms of expiration are met when the offer specifies that it may be used 10 times, and the user has utilized the offer 10 times. In response to determining that an offer's terms of expiration have been met, the offer engine 412 removes the offer object from the listing associated with that networking system user.

In one or more embodiments, the offer engine 412 determines whether a purchase has been initiated at the merchant-computing device 106. As discussed above, the communication manager 410 receives a notification from the payment processing system 114. Accordingly, the offer engine 412 determines that a purchase transaction has been initiated at the merchant-computing device 106 upon receipt of the notification of purchase from the payment processing system 114.

Upon determining that a purchase transaction has been initiated, the offer engine 412 utilizes information included with the purchase notification to identify a networking system user associated with the purchase. As described above, purchase notification includes a networking system unique identifier for the purchaser. In one or more embodiments, the offer engine 412 utilizes this unique identifier to identify the purchaser's networking system account.

In one or more embodiments, the offer engine 412 also identifies various user characteristics associated with the networking system user who has initiated the purchase transaction at the merchant-computing device 106. For example, in at least one embodiment, the offer engine 412 analyzes networking system activity information received by the communication manager 410 and associated with the networking system user to identify characteristics of the networking system user. To illustrate, the offer engine 412 can analyze networking system activity including articles the user has clicked on, digital photographs the user has uploaded, comments the user has entered, posts the user has liked, and so forth. From this analysis, the offer engine 412 can determine user characteristics including the user's age group, occupation, favorite hobbies, style choices, etc. In one or more embodiments, the offer engine 412 utilizes machine learning and other similar techniques to determine user characteristics based on the user's networking system activity.

Following the identification of various characteristics associated with the networking system user, the offer engine 412 identifies one or more offers available via the networking system 112 that apply to an initiated purchase. In one or more embodiments, the offer engine 412 identifies the one or more offers from the list of saved offers associated with the user. For example, if the purchase information indicates that the purchase transaction is for articles of the clothing, the offer engine 412 can identify one or more offers within the user's saved listing that are associated with both the merchant and clothing. The offer engine 412 identifies applicable offers using keyword matching, text matching, and/or metadata matching.

In addition embodiments, the offer engine 412 identifies offers that apply to the initiated purchase based on the user's identified characteristics and the purchase information. For example, purchase information for an initiated transaction may indicate that the purchase is for new running shoes. The offer engine 412 can further determine from the user's identified characteristics that the user also enjoys practicing yoga. Accordingly, the offer engine 412 identify additional offers associated with the merchant for yoga pants and tops and present those offers to the user, even though the user had not previously saved those offers to his listing of offers.

Additionally, the offer engine 412 updates offer information following the use of a particular offer. After the user selects one or more offers to apply to a purchase transaction at the merchant-computing device 106, the payment processing system 114 notifies the networking system 112 regarding the one or more offers that have been applied. Following receipt of this notification, the offer engine 412 updates information associated with the utilized one or more offers within the networking system 112. For example, the offer engine 412 can remove from the user's listing any offers that could only be used once. Further, the offer engine 412 can update information associated with an offer object that can be used up to a certain number of times to reflect that the offer has been used one additional time. The offer engine 412 can also determine whether additional instances of the offer saved by other users are still valid (e.g., the merchant specified a particular offer be made available to 1000 users, but only used 500 times).

In at least one embodiment, the offer engine 412 also generates an offer report for the merchant related to the use of the merchant's offers available via the networking system 112. As mentioned above, the offer management system can provide a use report to a merchant that includes information as to which of the merchant's offers have been saved by networking system users, which of the merchant's offers have been used by the networking system users, how long offers are typically saved before they are user, how long offers are available via the networking system before they are used, user's geographic regions where offers are saved and used, conversion rates associated with one or more offers, demographic information associated with users who apply the merchant's offers, and so forth. Accordingly, in at least one embodiment, the offer engine 412 collects the information requested by the merchant and assimilates the collected information into a coherent offer report. The offer engine 412 can update and provide the use report as often as scheduled or requested (e.g., daily, weekly, monthly, etc.).

Additionally, in one or more embodiments, the offer engine 412 also generates notifications for the user of the client-computing device 102 following the successful application of one or more offers. For example, in response to receiving one or more notifications from the payment processing system 114, the offer engine 412 generates a notification informing the user of the client-computing device 102 that the offer has successfully been applied. The notification can further include information regarding whether the offer is no longer valid or a number of remaining times the offer may be used before it is invalidated, etc. The offer engine 412 can cause the notification to be provided to the user via the networking system application 110a, which in turn can display the notification via a popup window, an icon notification, etc.

Furthermore, in one or more embodiments, the offer engine 412 generates notifications for the merchant. For example, in response to determining that an offer has successfully be applied to a purchase, the offer engine 412 can generate a merchant notification that includes a message stating the offer has been applied, as well as other information related to the offer. For instance, the offer engine 412 can include information from a generated offer report in the merchant notification.

As shown in FIG. 4, and as mentioned above, the networking system 112 also includes the data storage 414. The data storage 414 includes offer data 416. In one or more embodiments, the offer data 416 is representative of offer information, such as described herein.

Also shown in FIG. 4, the offer management system 100 includes the payment processing system 114 and the merchant-computing device 106 supporting the payment processing system application 116. In one or more embodiments, as described above, the payment processing system 114 is a third party system that handles a payment transaction and interfaces between the networking system 112 and the merchant-computing device 106 in order to provide offers to a networking system user. In at least one embodiment, the payment processing system 114 interfaces with the networking system 112 in response to a user swiping any payment card (i.e., the payment processing system 114 can be “card agnostic”). Furthermore, the payment processing system application 116 interfaces between the merchant-computing device 106 and the payment processing system 114.

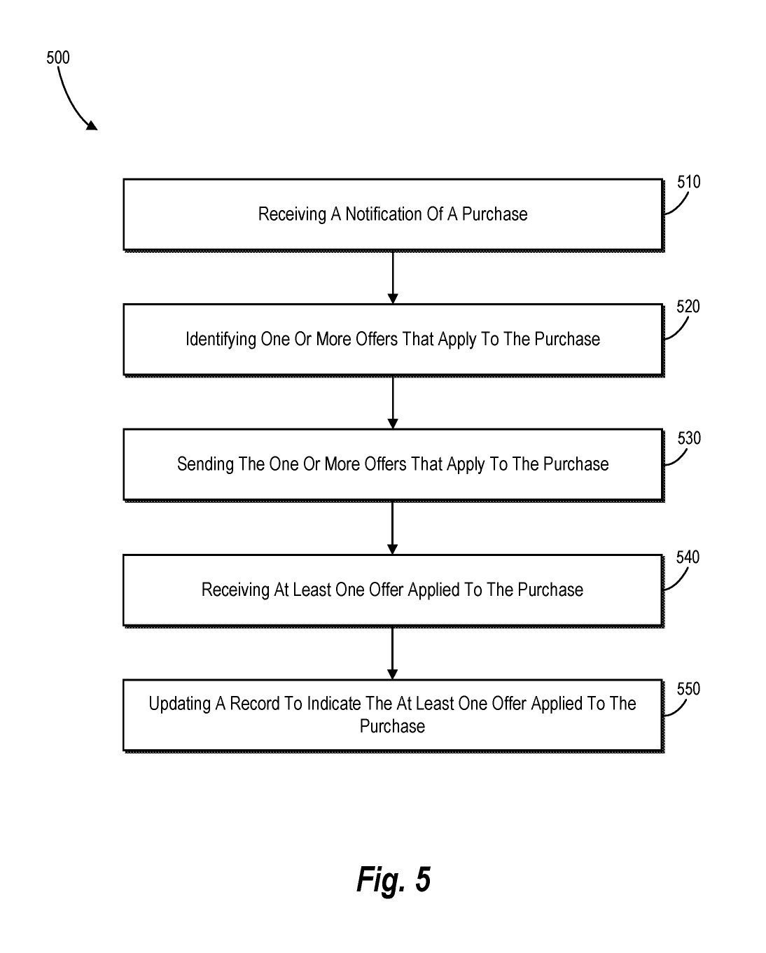

FIGS. 1-4, the corresponding text and examples, provide a number of different methods, systems, and devices for identifying and providing offers to networking system users for use in offline purchases. In addition to the foregoing, embodiments can also be described in terms of flowcharts comprising acts and steps in a method for accomplishing a particular result. For example, FIG. 5 may be performed with less or more steps/acts or the steps/acts may be performed in differing orders. Additionally, the steps/acts described herein may be repeated or performed in parallel with one another or in parallel with different instances of the same or similar steps/acts.

FIG. 5 illustrates a flowchart of one example method 500 of identifying and providing offers to networking system users for use in offline purchases. The method 500 includes an act 510 of receiving a notification of a purchase. In particular, the act 510 can involve receiving, at a networking system and from a payment processing system, a notification of a purchase initiated by a networking system user at a point of sale associated with a merchant. For example, in one embodiment, the notification of the purchase includes an identifier for the networking system user, an identifier for the merchant, and information associated with the purchase. In one or more embodiments, receiving the notification of the purchase is in response to a use of a credit card associated with the networking system user at the point of sale associated with the merchant.

Additionally, the method 500 includes an act 520 of identifying one or more offers that apply to the purchase. In particular, the act 520 can involve identifying, by the networking system and in response to the received notification, one or more offers available to the networking system user to apply to the purchase. For example, in at least one embodiment, identifying one or more offers available to apply to the purchase includes identifying, based on the identifier for the networking system user, a networking system account of the networking system user, identifying a plurality of offers associated with the networking system account, and identifying, based on the identifier for the merchant and the information associated with the purchase, a subset of the plurality of offers associated with the networking system account that are applicable to the purchase.

Furthermore, the method 500 includes an act 530 of sending the one or more offers that apply to the purchase. In particular, the act 530 can involve sending, to the payment processing system, an indication of the one or more offers available to apply to the purchase. For example, in one embodiment, sending the indication of the one or more offers available to apply to the purchase includes sending, for each of the one or more offers, a unique identifier associated with the offer.

The method 500 also includes an act 540 of receiving at least one offer applied to the purchase. In particular, the act 540 can involve receiving, from the payment processing system, an indication of at least one offer applied to the purchase at the point of sale. For example, in one embodiment, receiving the indication of at least one offer applied to the purchase comprises receiving the unique identifier associated with the at least one offer.

Additionally, the method 500 includes an act 550 of updating a record to indicate the at least one offer applied to the purchase. In particular, the act 550 can involve updating, in response to receiving the indication of the at least one offer applied to the purchase, a record at the networking system to indicate that the at least one offer has been applied to the purchase. In one or more embodiments, updating the record to indicate that the at least one offer has been applied to the purchase includes one or more of updating an account of the networking system user to indicate that the at least one offer has been applied to the purchase, or updating an account of the merchant to indicate that the at least one offer has been applied to the purchase.

For example, updating the account of the networking system user to indicate that the at least one offer has been applied to the purchase can include at least one of: updating information associated with the at least one offer to indicate the at least one offer is redeemed, increasing a punch-count associated with the offer, or identifying one or more additional offers related to the at least one offer and associating the identified one or more additional offers with the account of the networking system user. Furthermore, updating the account of the merchant to indicate that the at least one offer has been applied to the purchase includes an offer report associated with the merchant. For example, updating the offer report includes adding information to the report comprising one or more of: a unique identifier associated with the at least one offer, a conversion rate associated with the at least one offer, redemption information associated with the at least one offer, a number of offers associated with the merchant that are still available, information associated with the purchase, or demographic information associated with the networking system user.

Furthermore, in at least one embodiment, the method 500 includes an act of, prior to receiving the notification of the purchase, providing a plurality of offers to the networking system user, receiving a selection by the networking system user of the at least one offer, and associating the at least one offer with an account of the networking system user.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 6 illustrates a block diagram of exemplary computing device 600 that may be configured to perform one or more of the processes described above. One will appreciate that one or more computing devices such as the computing device 600 may implement the offer management system 100. As shown by FIG. 6, the computing device 600 can comprise a processor 602, a memory 604, a storage device 606, an I/O interface 608, and a communication interface 610, which may be communicatively coupled by way of a communication infrastructure 612. While an exemplary computing device 600 is shown in FIG. 6, the components illustrated in FIG. 6 are not intended to be limiting. Additional or alternative components may be used in other embodiments. Furthermore, in certain embodiments, the computing device 600 can include fewer components than those shown in FIG. 6. Components of the computing device 600 shown in FIG. 6 will now be described in additional detail.

In one or more embodiments, the processor 602 includes hardware for executing instructions, such as those making up a computer program. As an example and not by way of limitation, to execute instructions, the processor 602 may retrieve (or fetch) the instructions from an internal register, an internal cache, the memory 604, or the storage device 606 and decode and execute them. In one or more embodiments, the processor 602 may include one or more internal caches for data, instructions, or addresses. As an example and not by way of limitation, the processor 602 may include one or more instruction caches, one or more data caches, and one or more translation lookaside buffers (TLBs). Instructions in the instruction caches may be copies of instructions in the memory 604 or the storage device 606.

The memory 604 may be used for storing data, metadata, and programs for execution by the processor(s). The memory 604 may include one or more of volatile and non-volatile memories, such as Random Access Memory (“RAM”), Read Only Memory (“ROM”), a solid state disk (“SSD”), Flash, Phase Change Memory (“PCM”), or other types of data storage. The memory 604 may be internal or distributed memory.

The storage device 606 includes storage for storing data or instructions. As an example and not by way of limitation, storage device 606 can comprise a non-transitory storage medium described above. The storage device 606 may include a hard disk drive (HDD), a floppy disk drive, flash memory, an optical disc, a magneto-optical disc, magnetic tape, or a Universal Serial Bus (USB) drive or a combination of two or more of these. The storage device 606 may include removable or non-removable (or fixed) media, where appropriate. The storage device 606 may be internal or external to the computing device 600. In one or more embodiments, the storage device 606 is non-volatile, solid-state memory. In other embodiments, the storage device 606 includes read-only memory (ROM). Where appropriate, this ROM may be mask programmed ROM, programmable ROM (PROM), erasable PROM (EPROM), electrically erasable PROM (EEPROM), electrically alterable ROM (EAROM), or flash memory or a combination of two or more of these.

The I/O interface 608 allows a user to provide input to, receive output from, and otherwise transfer data to and receive data from computing device 600. The I/O interface 608 may include a mouse, a keypad or a keyboard, a touch screen, a camera, an optical scanner, network interface, modem, other known I/O devices or a combination of such I/O interfaces. The I/O interface 608 may include one or more devices for presenting output to a user, including, but not limited to, a graphics engine, a display (e.g., a display screen), one or more output drivers (e.g., display drivers), one or more audio speakers, and one or more audio drivers. In certain embodiments, the I/O interface 608 is configured to provide graphical data to a display for presentation to a user. The graphical data may be representative of one or more graphical user interfaces and/or any other graphical content as may serve a particular implementation.

The communication interface 610 can include hardware, software, or both. In any event, the communication interface 610 can provide one or more interfaces for communication (such as, for example, packet-based communication) between the computing device 600 and one or more other computing devices or networks. As an example and not by way of limitation, the communication interface 610 may include a network interface controller (NIC) or network adapter for communicating with an Ethernet or other wire-based network or a wireless NIC (WNIC) or wireless adapter for communicating with a wireless network, such as a WI-FI.

Additionally or alternatively, the communication interface 610 may facilitate communications with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, the communication interface 610 may facilitate communications with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof.

Additionally, the communication interface 610 may facilitate communications various communication protocols. Examples of communication protocols that may be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, Long Term Evolution (“LTE”) technologies, wireless communication technologies, in-band and out-of-band signaling technologies, and other suitable communications networks and technologies.

The communication infrastructure 612 may include hardware, software, or both that couples components of the computing device 600 to each other. As an example and not by way of limitation, the communication infrastructure 612 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

As mentioned above, the offer management system 100 can comprise a networking system. As used herein, a networking system refers to any type of system that enables its users (such as persons or organizations) to interact with the system and with each other. For example, a networking system can be a social networking system, a messaging system, etc. The networking system may, with input from a user, create and store in the networking system a user profile associated with the user. The user profile may include demographic information, communication-channel information, and information on personal interests of the user. The networking system may also, with input from a user, create and store a record of relationships of the user with other users of the networking system, as well as provide services (e.g., posts, photo-sharing, event organization, messaging, games, or advertisements) to facilitate social interaction between or among users.

The networking system may store records of users and relationships between users in a social graph comprising a plurality of nodes and a plurality of edges connecting the nodes. The nodes may comprise a plurality of user nodes and a plurality of concept nodes. A user node of the social graph may correspond to a user of the networking system. A user may be an individual (human user), an entity (e.g., an enterprise, business, or third party application), or a group (e.g., of individuals or entities). A user node corresponding to a user may comprise information provided by the user and information gathered by various systems, including the networking system.

For example, the user may provide his or her name, profile picture, city of residence, contact information, birth date, gender, marital status, family status, employment, educational background, preferences, interests, and other demographic information to be included in the user node. Each user node of the social graph may have a corresponding web page (typically known as a profile page). In response to a request including a user name, the networking system can access a user node corresponding to the user name, and construct a profile page including the name, a profile picture, and other information associated with the user. A profile page of a first user may display to a second user all or a portion of the first user's information based on one or more privacy settings by the first user and the relationship between the first user and the second user.

A concept node may correspond to a concept of the networking system. For example, a concept can represent a real-world entity, such as a movie, a song, a sports team, a celebrity, a group, a restaurant, or a place or a location. An administrative user of a concept node corresponding to a concept may create or update the concept node by providing information of the concept (e.g., by filling out an online form), causing the networking system to associate the information with the concept node. For example and without limitation, information associated with a concept can include a name or a title, one or more images (e.g., an image of cover page of a book), a web site (e.g., an URL address) or contact information (e.g., a phone number, an email address). Each concept node of the social graph may correspond to a web page. For example, in response to a request including a name, the networking system can access a concept node corresponding to the name, and construct a web page including the name and other information associated with the concept.

An edge between a pair of nodes may represent a relationship between the pair of nodes. For example, an edge between two user nodes can represent a friendship between two users. For another example, the networking system may construct a web page (or a structured document) of a concept node (e.g., a restaurant, a celebrity), incorporating one or more selectable option or selectable elements (e.g., “like”, “check in”) in the web page. A user can access the page using a web browser hosted by the user's client device and select a selectable option or selectable element, causing the client device to transmit to the networking system a request to create an edge between a user node of the user and a concept node of the concept, indicating a relationship between the user and the concept (e.g., the user checks in a restaurant, or the user “likes” a celebrity).

As an example, a user may provide (or change) his or her city of residence, causing the networking system to create an edge between a user node corresponding to the user and a concept node corresponding to the city declared by the user as his or her city of residence. In addition, the degree of separation between any two nodes is defined as the minimum number of hops required to traverse the social graph from one node to the other. A degree of separation between two nodes can be considered a measure of relatedness between the users or the concepts represented by the two nodes in the social graph. For example, two users having user nodes that are directly connected by an edge (i.e., are first-degree nodes) may be described as “connected users” or “friends.” Similarly, two users having user nodes that are connected only through another user node (i.e., are second-degree nodes) may be described as “friends of friends.”

A networking system may support a variety of applications, such as photo sharing, on-line calendars and events, gaming, instant messaging, and advertising. For example, the networking system may also include media sharing capabilities. Also, the networking system may allow users to post photographs and other multimedia content items to a user's profile page (typically known as “wall posts” or “timeline posts”) or in a photo album, both of which may be accessible to other users of the networking system depending upon the user's configured privacy settings. The networking system may also allow users to configure events. For example, a first user may configure an event with attributes including time and date of the event, location of the event and other users invited to the event. The invited users may receive invitations to the event and respond (such as by accepting the invitation or declining it). Furthermore, the networking system may allow users to maintain a personal calendar. Similarly to events, the calendar entries may include times, dates, locations and identities of other users.

FIG. 7 illustrates an example network environment 700 of a networking system. Network environment 700 includes a client device 706, a networking system 702, and a third-party system 708 connected to each other by a network 704. Although FIG. 7 illustrates a particular arrangement of client device 706, networking system 702, third-party system 708, and network 704, this disclosure contemplates any suitable arrangement of client device 706, networking system 702, third-party system 708, and network 704. As an example and not by way of limitation, two or more of client device 706, networking system 702, and third-party system 708 may be connected to each other directly, bypassing network 704. As another example, two or more of client device 706, networking system 702, and third-party system 708 may be physically or logically co-located with each other in whole or in part. Moreover, although FIG. 7 illustrates a particular number of client devices 706, networking systems 702, third-party systems 708, and networks 704, this disclosure contemplates any suitable number of client devices 706, networking systems 702, third-party systems 708, and networks 704. As an example and not by way of limitation, network environment 700 may include multiple client device 706, networking systems 702, third-party systems 708, and networks 704.

This disclosure contemplates any suitable network 704. As an example and not by way of limitation, one or more portions of network 704 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 704 may include one or more networks 704.

Links may connect client device 706, networking system 702, and third-party system 708 to communication network 704 or to each other. This disclosure contemplates any suitable links. In particular embodiments, one or more links include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout network environment 700. One or more first links may differ in one or more respects from one or more second links.

In particular embodiments, client device 706 may be an electronic device including hardware, software, or embedded logic components or a combination of two or more such components and capable of carrying out the appropriate functionalities implemented or supported by client device 706. As an example and not by way of limitation, a client device 706 may include a computer system such as a desktop computer, notebook or laptop computer, netbook, a tablet computer, e-book reader, GPS device, camera, personal digital assistant (PDA), handheld electronic device, cellular telephone, smartphone, other suitable electronic device, or any suitable combination thereof. This disclosure contemplates any suitable client devices 706. A client device 706 may enable a network user at client device 706 to access network 704. A client device 706 may enable its user to communicate with other users at other client devices 706.

In particular embodiments, client device 706 may include a web browser, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at client device 706 may enter a Uniform Resource Locator (URL) or other address directing the web browser to a particular server (such as server, or a server associated with a third-party system 708), and the web browser may generate a Hyper Text Transfer Protocol (HTTP) request and communicate the HTTP request to server. The server may accept the HTTP request and communicate to client device 706 one or more Hyper Text Markup Language (HTML) files responsive to the HTTP request. Client device 706 may render a webpage based on the HTML files from the server for presentation to the user. This disclosure contemplates any suitable webpage files. As an example and not by way of limitation, webpages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, networking system 702 may be a network-addressable computing system that can host an online social network. Networking system 702 may generate, store, receive, and send social-networking data, such as, for example, user-profile data, concept-profile data, social-graph information, or other suitable data related to the online social network. Networking system 702 may be accessed by the other components of network environment 700 either directly or via network 704. In particular embodiments, networking system 702 may include one or more servers. Each server may be a unitary server or a distributed server spanning multiple computers or multiple datacenters. Servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by server. In particular embodiments, networking system 702 may include one or more data stores. Data stores may be used to store various types of information. In particular embodiments, the information stored in data stores may be organized according to specific data structures. In particular embodiments, each data store may be a relational, columnar, correlation, or other suitable database. Although this disclosure describes or illustrates particular types of databases, this disclosure contemplates any suitable types of databases. Particular embodiments may provide interfaces that enable a client device 706, a networking system 702, or a third-party system 708 to manage, retrieve, modify, add, or delete, the information stored in data store.

In particular embodiments, networking system 702 may store one or more social graphs in one or more data stores. In particular embodiments, a social graph may include multiple nodes—which may include multiple user nodes (each corresponding to a particular user) or multiple concept nodes (each corresponding to a particular concept)—and multiple edges connecting the nodes. Networking system 702 may provide users of the online social network the ability to communicate and interact with other users. In particular embodiments, users may join the online social network via networking system 702 and then add connections (e.g., relationships) to a number of other users of networking system 702 whom they want to be connected to. Herein, the term “friend” may refer to any other user of networking system 702 with whom a user has formed a connection, association, or relationship via networking system 702.

In particular embodiments, networking system 702 may provide users with the ability to take actions on various types of items or objects, supported by networking system 702. As an example and not by way of limitation, the items and objects may include groups or social networks to which users of networking system 702 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in networking system 702 or by an external system of third-party system 708, which is separate from networking system 702 and coupled to networking system 702 via a network 704.

In particular embodiments, networking system 702 may be capable of linking a variety of entities. As an example and not by way of limitation, networking system 702 may enable users to interact with each other as well as receive content from third-party systems 708 or other entities, or to allow users to interact with these entities through an application programming interfaces (API) or other communication channels.

In particular embodiments, a third-party system 708 may include one or more types of servers, one or more data stores, one or more interfaces, including but not limited to APIs, one or more web services, one or more content sources, one or more networks, or any other suitable components, e.g., that servers may communicate with. A third-party system 708 may be operated by a different entity from an entity operating networking system 702. In particular embodiments, however, networking system 702 and third-party systems 708 may operate in conjunction with each other to provide social-networking services to users of networking system 702 or third-party systems 708. In this sense, networking system 702 may provide a platform, or backbone, which other systems, such as third-party systems 708, may use to provide social-networking services and functionality to users across the Internet.

In particular embodiments, a third-party system 708 may include a third-party content object provider. A third-party content object provider may include one or more sources of content objects, which may be communicated to a client device 706. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, networking system 702 also includes user-generated content objects, which may enhance a user's interactions with networking system 702. User-generated content may include anything a user can add, upload, send, or “post” to networking system 702. As an example and not by way of limitation, a user communicates posts to networking system 702 from a client device 706. Posts may include data such as status updates or other textual data, location information, photos, videos, links, music or other similar data or media. Content may also be added to networking system 702 by a third-party through a “communication channel,” such as a newsfeed or stream.

In particular embodiments, networking system 702 may include a variety of servers, sub-systems, programs, modules, logs, and data stores. In particular embodiments, networking system 702 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. Networking system 702 may also include suitable components such as network interfaces, security mechanisms, load balancers, failover servers, management-and-network-operations consoles, other suitable components, or any suitable combination thereof. In particular embodiments, networking system 702 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking networking system 702 to one or more client devices 706 or one or more third-party system 708 via network 704. The web server may include a mail server or other messaging functionality for receiving and routing messages between networking system 702 and one or more client devices 706. An API-request server may allow a third-party system 708 to access information from networking system 702 by calling one or more APIs. An action logger may be used to receive communications from a web server about a user's actions on or off networking system 702. In conjunction with the action log, a third-party-content-object log may be maintained of user exposures to third-party-content objects. A notification controller may provide information regarding content objects to a client device 706. Information may be pushed to a client device 706 as notifications, or information may be pulled from client device 706 responsive to a request received from client device 706. Authorization servers may be used to enforce one or more privacy settings of the users of networking system 702. A privacy setting of a user determines how particular information associated with a user can be shared. The authorization server may allow users to opt in to or opt out of having their actions logged by networking system 702 or shared with other systems (e.g., third-party system 708), such as, for example, by setting appropriate privacy settings. Third-party-content-object stores may be used to store content objects received from third parties, such as a third-party system 708. Location stores may be used for storing location information received from client devices 706 associated with users. Advertisement-pricing modules may combine social information, the current time, location information, or other suitable information to provide relevant advertisements, in the form of notifications, to a user.

FIG. 8 illustrates example social graph 800. In particular embodiments, networking system 702 may store one or more social graphs 800 in one or more data stores. In particular embodiments, social graph 800 may include multiple nodes—which may include multiple user nodes 802 or multiple concept nodes 804—and multiple edges 806 connecting the nodes. Example social graph 800 illustrated in FIG. 8 is shown, for didactic purposes, in a two-dimensional visual map representation. In particular embodiments, a networking system 702, client device 706, or third-party system 708 may access social graph 800 and related social-graph information for suitable applications. The nodes and edges of social graph 800 may be stored as data objects, for example, in a data store (such as a social-graph database). Such a data store may include one or more searchable or query able indexes of nodes or edges of social graph 800.

In particular embodiments, a user node 802 may correspond to a user of networking system 702. As an example and not by way of limitation, a user may be an individual (human user), an entity (e.g., an enterprise, business, or third-party application), or a group (e.g., of individuals or entities) that interacts or communicates with or over networking system 702. In particular embodiments, when a user registers for an account with networking system 702, networking system 702 may create a user node 802 corresponding to the user, and store the user node 802 in one or more data stores. Users and user nodes 802 described herein may, where appropriate, refer to registered users and user nodes 802 associated with registered users. In addition or as an alternative, users and user nodes 802 described herein may, where appropriate, refer to users that have not registered with networking system 702. In particular embodiments, a user node 802 may be associated with information provided by a user or information gathered by various systems, including networking system 702. As an example and not by way of limitation, a user may provide his or her name, profile picture, contact information, birth date, sex, marital status, family status, employment, education background, preferences, interests, or other demographic information. In particular embodiments, a user node 802 may be associated with one or more data objects corresponding to information associated with a user. In particular embodiments, a user node 802 may correspond to one or more webpages.

In particular embodiments, a concept node 804 may correspond to a concept. As an example and not by way of limitation, a concept may correspond to a place (such as, for example, a movie theater, restaurant, landmark, or city); a website (such as, for example, a website associated with networking system 702 or a third-party website associated with a web-application server); an entity (such as, for example, a person, business, group, sports team, or celebrity); a resource (such as, for example, an audio file, video file, digital photo, text file, structured document, or application) which may be located within networking system 702 or on an external server, such as a web-application server; real or intellectual property (such as, for example, a sculpture, painting, movie, game, song, idea, photograph, or written work); a game; an activity; an idea or theory; another suitable concept; or two or more such concepts. A concept node 804 may be associated with information of a concept provided by a user or information gathered by various systems, including networking system 702. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 804 may be associated with one or more data objects corresponding to information associated with concept node 804. In particular embodiments, a concept node 804 may correspond to one or more webpages.

In particular embodiments, a node in social graph 800 may represent or be represented by a webpage (which may be referred to as a “profile page”). Profile pages may be hosted by or accessible to networking system 702. Profile pages may also be hosted on third-party websites associated with a third-party system 708. As an example and not by way of limitation, a profile page corresponding to a particular external webpage may be the particular external webpage and the profile page may correspond to a particular concept node 804. Profile pages may be viewable by all or a selected subset of other users. As an example and not by way of limitation, a user node 802 may have a corresponding user-profile page in which the corresponding user may add content, make declarations, or otherwise express himself or herself. As another example and not by way of limitation, a concept node 804 may have a corresponding concept-profile page in which one or more users may add content, make declarations, or express themselves, particularly in relation to the concept corresponding to concept node 804.

In particular embodiments, a concept node 804 may represent a third-party webpage or resource hosted by a third-party system 708. The third-party webpage or resource may include, among other elements, content, a selectable or other icon, or other inter-actable object (which may be implemented, for example, in JavaScript, AJAX, or PHP codes) representing an action or activity. As an example and not by way of limitation, a third-party webpage may include a selectable icon such as “like,” “check in,” “eat,” “recommend,” or another suitable action or activity. A user viewing the third-party webpage may perform an action by selecting one of the icons (e.g., “eat”), causing a client device 706 to send to networking system 702 a message indicating the user's action. In response to the message, networking system 702 may create an edge (e.g., an “eat” edge) between a user node 802 corresponding to the user and a concept node 804 corresponding to the third-party webpage or resource and store edge 806 in one or more data stores.

In particular embodiments, a pair of nodes in social graph 800 may be connected to each other by one or more edges 806. An edge 806 connecting a pair of nodes may represent a relationship between the pair of nodes. In particular embodiments, an edge 806 may include or represent one or more data objects or attributes corresponding to the relationship between a pair of nodes. As an example and not by way of limitation, a first user may indicate that a second user is a “friend” of the first user. In response to this indication, networking system 702 may send a “friend request” to the second user. If the second user confirms the “friend request,” networking system 702 may create an edge 806 connecting the first user's user node 802 to the second user's user node 802 in social graph 800 and store edge 806 as social-graph information in one or more of data stores. In the example of FIG. 8, social graph 800 includes an edge 806 indicating a friend relation between user nodes 802 of user “A” and user “B” and an edge indicating a friend relation between user nodes 802 of user “C” and user “B.” Although this disclosure describes or illustrates particular edges 806 with particular attributes connecting particular user nodes 802, this disclosure contemplates any suitable edges 806 with any suitable attributes connecting user nodes 802. As an example and not by way of limitation, an edge 806 may represent a friendship, family relationship, business or employment relationship, fan relationship, follower relationship, visitor relationship, sub scriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 800 by one or more edges 806.

In particular embodiments, an edge 806 between a user node 802 and a concept node 804 may represent a particular action or activity performed by a user associated with user node 802 toward a concept associated with a concept node 804. As an example and not by way of limitation, as illustrated in FIG. 8, a user may “like,” “attended,” “played,” “listened,” “cooked,” “worked at,” or “watched” a concept, each of which may correspond to an edge type or subtype. A concept-profile page corresponding to a concept node 804 may include, for example, a selectable “check in” icon (such as, for example, a clickable “check in” icon) or a selectable “add to favorites” icon. Similarly, after a user clicks these icons, networking system 702 may create a “favorite” edge or a “check in” edge in response to a user's action corresponding to a respective action. As another example and not by way of limitation, a user (user “C”) may listen to a particular song (“Ramble On”) using a particular application (SPOTIFY, which is an online music application). In this case, networking system 702 may create a “listened” edge 806 and a “used” edge (as illustrated in FIG. 8) between user nodes 802 corresponding to the user and concept nodes 804 corresponding to the song and application to indicate that the user listened to the song and used the application. Moreover, networking system 702 may create a “played” edge 806 (as illustrated in FIG. 8) between concept nodes 804 corresponding to the song and the application to indicate that the particular song was played by the particular application. In this case, “played” edge 806 corresponds to an action performed by an external application (SPOTIFY) on an external audio file (the song “Imagine”). Although this disclosure describes particular edges 806 with particular attributes connecting user nodes 802 and concept nodes 804, this disclosure contemplates any suitable edges 806 with any suitable attributes connecting user nodes 802 and concept nodes 804. Moreover, although this disclosure describes edges between a user node 802 and a concept node 804 representing a single relationship, this disclosure contemplates edges between a user node 802 and a concept node 804 representing one or more relationships. As an example and not by way of limitation, an edge 806 may represent both that a user likes and has used at a particular concept. Alternatively, another edge 806 may represent each type of relationship (or multiples of a single relationship) between a user node 802 and a concept node 804 (as illustrated in FIG. 8 between user node 802 for user “E” and concept node 804 for “SPOTIFY”).

In particular embodiments, networking system 702 may create an edge 806 between a user node 802 and a concept node 804 in social graph 800. As an example and not by way of limitation, a user viewing a concept-profile page (such as, for example, by using a web browser or a special-purpose application hosted by the user's client device 706) may indicate that he or she likes the concept represented by the concept node 804 by clicking or selecting a “Like” icon, which may cause the user's client device 706 to send to networking system 702 a message indicating the user's liking of the concept associated with the concept-profile page. In response to the message, networking system 702 may create an edge 806 between user node 802 associated with the user and concept node 804, as illustrated by “like” edge 806 between the user and concept node 804. In particular embodiments, networking system 702 may store an edge 806 in one or more data stores. In particular embodiments, an edge 806 may be automatically formed by networking system 702 in response to a particular user action. As an example and not by way of limitation, if a first user uploads a picture, watches a movie, or listens to a song, an edge 806 may be formed between user node 802 corresponding to the first user and concept nodes 804 corresponding to those concepts. Although this disclosure describes forming particular edges 806 in particular manners, this disclosure contemplates forming any suitable edges 806 in any suitable manner.

In particular embodiments, an advertisement may be text (which may be HTML-linked), one or more images (which may be HTML-linked), one or more videos, audio, one or more ADOBE FLASH files, a suitable combination of these, or any other suitable advertisement in any suitable digital format presented on one or more webpages, in one or more e-mails, or in connection with search results requested by a user. In addition or as an alternative, an advertisement may be one or more sponsored stories (e.g., a news-feed or ticker item on networking system 702). A sponsored story may be a social action by a user (such as “liking” a page, “liking” or commenting on a post on a page, RSVPing to an event associated with a page, voting on a question posted on a page, checking in to a place, using an application or playing a game, or “liking” or sharing a website) that an advertiser promotes, for example, by having the social action presented within a pre-determined area of a profile page of a user or other page, presented with additional information associated with the advertiser, bumped up or otherwise highlighted within news feeds or tickers of other users, or otherwise promoted. The advertiser may pay to have the social action promoted. As an example and not by way of limitation, advertisements may be included among the search results of a search-results page, where sponsored content is promoted over non-sponsored content.

In particular embodiments, an advertisement may be requested for display within social-networking-system webpages, third-party webpages, or other pages. An advertisement may be displayed in a dedicated portion of a page, such as in a banner area at the top of the page, in a column at the side of the page, in a GUI of the page, in a pop-up window, in a drop-down menu, in an input field of the page, over the top of content of the page, or elsewhere with respect to the page. In addition or as an alternative, an advertisement may be displayed within an application. An advertisement may be displayed within dedicated pages, requiring the user to interact with or watch the advertisement before the user may access a page or utilize an application. The user may, for example view the advertisement through a web browser.

A user may interact with an advertisement in any suitable manner. The user may click or otherwise select the advertisement. By selecting the advertisement, the user may be directed to (or a browser or other application being used by the user) a page associated with the advertisement. At the page associated with the advertisement, the user may take additional actions, such as purchasing a product or service associated with the advertisement, receiving information associated with the advertisement, or subscribing to a newsletter associated with the advertisement. An advertisement with audio or video may be played by selecting a component of the advertisement (like a “play button”). Alternatively, by selecting the advertisement, networking system 702 may execute or modify a particular action of the user.

An advertisement may also include social-networking-system functionality that a user may interact with. As an example and not by way of limitation, an advertisement may enable a user to “like” or otherwise endorse the advertisement by selecting an icon or link associated with endorsement. As another example and not by way of limitation, an advertisement may enable a user to search (e.g., by executing a query) for content related to the advertiser. Similarly, a user may share the advertisement with another user (e.g., through networking system 702) or RSVP (e.g., through networking system 702) to an event associated with the advertisement. In addition or as an alternative, an advertisement may include social-networking-system context directed to the user. As an example and not by way of limitation, an advertisement may display information about a friend of the user within networking system 702 who has taken an action associated with the subject matter of the advertisement.

In particular embodiments, networking system 702 may determine the social-graph affinity (which may be referred to herein as “affinity”) of various social-graph entities for each other. Affinity may represent the strength of a relationship or level of interest between particular objects associated with the online social network, such as users, concepts, content, actions, advertisements, other objects associated with the online social network, or any suitable combination thereof. Affinity may also be determined with respect to objects associated with third-party systems 708 or other suitable systems. An overall affinity for a social-graph entity for each user, subject matter, or type of content may be established. The overall affinity may change based on continued monitoring of the actions or relationships associated with the social-graph entity. Although this disclosure describes determining particular affinities in a particular manner, this disclosure contemplates determining any suitable affinities in any suitable manner.

In particular embodiments, networking system 702 may measure or quantify social-graph affinity using an affinity coefficient (which may be referred to herein as “coefficient”). The coefficient may represent or quantify the strength of a relationship between particular objects associated with the online social network. The coefficient may also represent a probability or function that measures a predicted probability that a user will perform a particular action based on the user's interest in the action. In this way, a user's future actions may be predicted based on the user's prior actions, where the coefficient may be calculated at least in part based on the history of the user's actions. Coefficients may be used to predict any number of actions, which may be within or outside of the online social network. As an example and not by way of limitation, these actions may include various types of communications, such as sending messages, posting content, or commenting on content; various types of observation actions, such as accessing or viewing profile pages, media, or other suitable content; various types of coincidence information about two or more social-graph entities, such as being in the same group, tagged in the same photograph, checked-in at the same location, or attending the same event; or other suitable actions. Although this disclosure describes measuring affinity in a particular manner, this disclosure contemplates measuring affinity in any suitable manner.

In particular embodiments, networking system 702 may use a variety of factors to calculate a coefficient. These factors may include, for example, user actions, types of relationships between objects, location information, other suitable factors, or any combination thereof. In particular embodiments, different factors may be weighted differently when calculating the coefficient. The weights for each factor may be static or the weights may change according to, for example, the user, the type of relationship, the type of action, the user's location, and so forth. Ratings for the factors may be combined according to their weights to determine an overall coefficient for the user. As an example and not by way of limitation, particular user actions may be assigned both a rating and a weight while a relationship associated with the particular user action is assigned a rating and a correlating weight (e.g., so the weights total 100%). To calculate the coefficient of a user towards a particular object, the rating assigned to the user's actions may comprise, for example, 60% of the overall coefficient, while the relationship between the user and the object may comprise 40% of the overall coefficient. In particular embodiments, the networking system 702 may consider a variety of variables when determining weights for various factors used to calculate a coefficient, such as, for example, the time since information was accessed, decay factors, frequency of access, relationship to information or relationship to the object about which information was accessed, relationship to social-graph entities connected to the object, short- or long-term averages of user actions, user feedback, other suitable variables, or any combination thereof. As an example and not by way of limitation, a coefficient may include a decay factor that causes the strength of the signal provided by particular actions to decay with time, such that more recent actions are more relevant when calculating the coefficient. The ratings and weights may be continuously updated based on continued tracking of the actions upon which the coefficient is based. Any type of process or algorithm may be employed for assigning, combining, averaging, and so forth the ratings for each factor and the weights assigned to the factors. In particular embodiments, networking system 702 may determine coefficients using machine-learning algorithms trained on historical actions and past user responses, or data farmed from users by exposing them to various options and measuring responses. Although this disclosure describes calculating coefficients in a particular manner, this disclosure contemplates calculating coefficients in any suitable manner.

In particular embodiments, networking system 702 may calculate a coefficient based on a user's actions. Networking system 702 may monitor such actions on the online social network, on a third-party system 708, on other suitable systems, or any combination thereof. Any suitable type of user actions may be tracked or monitored. Typical user actions include viewing profile pages, creating or posting content, interacting with content, joining groups, listing and confirming attendance at events, checking-in at locations, liking particular pages, creating pages, and performing other tasks that facilitate social action. In particular embodiments, networking system 702 may calculate a coefficient based on the user's actions with particular types of content. The content may be associated with the online social network, a third-party system 708, or another suitable system. The content may include users, profile pages, posts, news stories, headlines, instant messages, chat room conversations, emails, advertisements, pictures, video, music, other suitable objects, or any combination thereof. Networking system 702 may analyze a user's actions to determine whether one or more of the actions indicate an affinity for subject matter, content, other users, and so forth. As an example and not by way of limitation, if a user may make frequently posts content related to “coffee” or variants thereof, networking system 702 may determine the user has a high coefficient with respect to the concept “coffee”. Particular actions or types of actions may be assigned a higher weight and/or rating than other actions, which may affect the overall calculated coefficient. As an example and not by way of limitation, if a first user emails a second user, the weight or the rating for the action may be higher than if the first user simply views the user-profile page for the second user.

In particular embodiments, networking system 702 may calculate a coefficient based on the type of relationship between particular objects. Referencing the social graph 800, networking system 702 may analyze the number and/or type of edges 806 connecting particular user nodes 802 and concept nodes 804 when calculating a coefficient. As an example and not by way of limitation, user nodes 802 that are connected by a spouse-type edge (representing that the two users are married) may be assigned a higher coefficient than a user node 802 that are connected by a friend-type edge. In other words, depending upon the weights assigned to the actions and relationships for the particular user, the overall affinity may be determined to be higher for content about the user's spouse than for content about the user's friend. In particular embodiments, the relationships a user has with another object may affect the weights and/or the ratings of the user's actions with respect to calculating the coefficient for that object. As an example and not by way of limitation, if a user is tagged in first photo, but merely likes a second photo, networking system 702 may determine that the user has a higher coefficient with respect to the first photo than the second photo because having a tagged-in-type relationship with content may be assigned a higher weight and/or rating than having a like-type relationship with content. In particular embodiments, networking system 702 may calculate a coefficient for a first user based on the relationship one or more second users have with a particular object. In other words, the connections and coefficients other users have with an object may affect the first user's coefficient for the object. As an example and not by way of limitation, if a first user is connected to or has a high coefficient for one or more second users, and those second users are connected to or have a high coefficient for a particular object, networking system 702 may determine that the first user should also have a relatively high coefficient for the particular object. In particular embodiments, the coefficient may be based on the degree of separation between particular objects. The lower coefficient may represent the decreasing likelihood that the first user will share an interest in content objects of the user that is indirectly connected to the first user in the social graph 800. As an example and not by way of limitation, social-graph entities that are closer in the social graph 800 (i.e., fewer degrees of separation) may have a higher coefficient than entities that are further apart in the social graph 800.

In particular embodiments, networking system 702 may calculate a coefficient based on location information. Objects that are geographically closer to each other may be considered to be more related, or of more interest, to each other than more distant objects. In particular embodiments, the coefficient of a user towards a particular object may be based on the proximity of the object's location to a current location associated with the user (or the location of a client device 706 of the user). A first user may be more interested in other users or concepts that are closer to the first user. As an example and not by way of limitation, if a user is one mile from an airport and two miles from a gas station, networking system 702 may determine that the user has a higher coefficient for the airport than the gas station based on the proximity of the airport to the user.

In particular embodiments, networking system 702 may perform particular actions with respect to a user based on coefficient information. Coefficients may be used to predict whether a user will perform a particular action based on the user's interest in the action. A coefficient may be used when generating or presenting any type of objects to a user, such as advertisements, search results, news stories, media, messages, notifications, or other suitable objects. The coefficient may also be utilized to rank and order such objects, as appropriate. In this way, networking system 702 may provide information that is relevant to user's interests and current circumstances, increasing the likelihood that they will find such information of interest. In particular embodiments, networking system 702 may generate content based on coefficient information. Content objects may be provided or selected based on coefficients specific to a user. As an example and not by way of limitation, the coefficient may be used to generate media for the user, where the user may be presented with media for which the user has a high overall coefficient with respect to the media object. As another example and not by way of limitation, the coefficient may be used to generate advertisements for the user, where the user may be presented with advertisements for which the user has a high overall coefficient with respect to the advertised object. In particular embodiments, networking system 702 may generate search results based on coefficient information. Search results for a particular user may be scored or ranked based on the coefficient associated with the search results with respect to the querying user. As an example and not by way of limitation, search results corresponding to objects with higher coefficients may be ranked higher on a search-results page than results corresponding to objects having lower coefficients.

In particular embodiments, networking system 702 may calculate a coefficient in response to a request for a coefficient from a particular system or process. To predict the likely actions a user may take (or may be the subject of) in a given situation, any process may request a calculated coefficient for a user. The request may also include a set of weights to use for various factors used to calculate the coefficient. This request may come from a process running on the online social network, from a third-party system 708 (e.g., via an API or other communication channel), or from another suitable system. In response to the request, networking system 702 may calculate the coefficient (or access the coefficient information if it has previously been calculated and stored). In particular embodiments, networking system 702 may measure an affinity with respect to a particular process. Different processes (both internal and external to the online social network) may request a coefficient for a particular object or set of objects. Networking system 702 may provide a measure of affinity that is relevant to the particular process that requested the measure of affinity. In this way, each process receives a measure of affinity that is tailored for the different context in which the process will use the measure of affinity.

In connection with social-graph affinity and affinity coefficients, particular embodiments may utilize one or more systems, components, elements, functions, methods, operations, or steps disclosed in U.S. patent application Ser. No. 11/503,093, filed 11 Aug. 2006, U.S. patent application Ser. No. 12/977,027, filed 22 Dec. 2010, U.S. patent application Ser. No. 12/978,265, filed 23 Dec. 2010, and U.S. patent application Ser. No. 13/632,869, field 1 Oct. 2012, each of which is incorporated by reference.

In particular embodiments, one or more of the content objects of the online social network may be associated with a privacy setting. The privacy settings (or “access settings”) for an object may be stored in any suitable manner, such as, for example, in association with the object, in an index on an authorization server, in another suitable manner, or any combination thereof. A privacy setting of an object may specify how the object (or particular information associated with an object) can be accessed (e.g., viewed or shared) using the online social network. Where the privacy settings for an object allow a particular user to access that object, the object may be described as being “visible” with respect to that user. As an example and not by way of limitation, a user of the online social network may specify privacy settings for a user-profile page identify a set of users that may access the work experience information on the user-profile page, thus excluding other users from accessing the information. In particular embodiments, the privacy settings may specify a “blocked list” of users that should not be allowed to access certain information associated with the object. In other words, the blocked list may specify one or more users or entities for which an object is not visible. As an example and not by way of limitation, a user may specify a set of users that may not access photos albums associated with the user, thus excluding those users from accessing the photo albums (while also possibly allowing certain users not within the set of users to access the photo albums). In particular embodiments, privacy settings may be associated with particular social-graph elements. Privacy settings of a social-graph element, such as a node or an edge, may specify how the social-graph element, information associated with the social-graph element, or content objects associated with the social-graph element can be accessed using the online social network. As an example and not by way of limitation, a particular concept node 804 corresponding to a particular photo may have a privacy setting specifying that the photo may only be accessed by users tagged in the photo and their friends. In particular embodiments, privacy settings may allow users to opt in or opt out of having their actions logged by networking system 702 or shared with other systems (e.g., third-party system 708). In particular embodiments, the privacy settings associated with an object may specify any suitable granularity of permitted access or denial of access. As an example and not by way of limitation, access or denial of access may be specified for particular users (e.g., only me, my roommates, and my boss), users within a particular degrees-of-separation (e.g., friends, or friends-of-friends), user groups (e.g., the gaming club, my family), user networks (e.g., employees of particular employers, students or alumni of particular university), all users (“public”), no users (“private”), users of third-party systems 708, particular applications (e.g., third-party applications, external websites), other suitable users or entities, or any combination thereof. Although this disclosure describes using particular privacy settings in a particular manner, this disclosure contemplates using any suitable privacy settings in any suitable manner.

In particular embodiments, one or more servers may be authorization/privacy servers for enforcing privacy settings. In response to a request from a user (or other entity) for a particular object stored in a data store, networking system 702 may send a request to the data store for the object. The request may identify the user associated with the request and may only be sent to the user (or a client device 706 of the user) if the authorization server determines that the user is authorized to access the object based on the privacy settings associated with the object. If the requesting user is not authorized to access the object, the authorization server may prevent the requested object from being retrieved from the data store, or may prevent the requested object from be sent to the user. In the search query context, an object may only be generated as a search result if the querying user is authorized to access the object. In other words, the object must have a visibility that is visible to the querying user. If the object has a visibility that is not visible to the user, the object may be excluded from the search results. Although this disclosure describes enforcing privacy settings in a particular manner, this disclosure contemplates enforcing privacy settings in any suitable manner.

The foregoing specification is described with reference to specific exemplary embodiments thereof. Various embodiments and aspects of the disclosure are described with reference to details discussed herein, and the accompanying drawings illustrate the various embodiments. The description above and drawings are illustrative and are not to be construed as limiting. Numerous specific details are described to provide a thorough understanding of various embodiments.

The additional or alternative embodiments may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A method comprising:
receiving, at a networking system and from a payment processing system, a notification of a purchase initiated by a networking system user at a point of sale associated with a merchant;
identifying, by the networking system and in response to the received notification, one or more offers available to the networking system user to apply to the purchase;
sending, to the payment processing system, an indication of the one or more offers available to apply to the purchase;
receiving, from the payment processing system, an indication of at least one offer applied to the purchase at the point of sale; and
updating, in response to receiving the indication of the at least one offer applied to the purchase, a record at the networking system to indicate that the at least one offer has been applied to the purchase.

2. The method as recited in claim 1, wherein the notification of the purchase comprises an identifier for the networking system user, an identifier for the merchant, and information associated with the purchase.

3. The method as recited in claim 2, wherein identifying one or more offers available to apply to the purchase comprises:
identifying, based on the identifier for the networking system user, a networking system account of the networking system user;
identifying a plurality of offers associated with the networking system account; and
identifying, based on the identifier for the merchant and the information associated with the purchase, a subset of the plurality of offers associated with the networking system account that are applicable to the purchase.

4. The method as recited in claim 1, wherein:
sending the indication of the one or more offers available to apply to the purchase comprises sending, for each of the one or more offers, a unique identifier associated with the offer; and
receiving the indication of at least one offer applied to the purchase comprises receiving the unique identifier associated with the at least one offer.

5. The method as recited in claim 1, wherein updating the record to indicate that the at least one offer has been applied to the purchase comprises one or more of:
updating an account of the networking system user to indicate that the at least one offer has been applied to the purchase; or
updating an account of the merchant to indicate that the at least one offer has been applied to the purchase.

6. The method of claim 5, wherein updating the account of the networking system user to indicate that the at least one offer has been applied to the purchase comprises at least one of:
updating information associated with the at least one offer to indicate the at least one offer is redeemed;
increasing a punch-count associated with the offer; or
identifying one or more additional offers related to the at least one offer and associating the identified one or more additional offers with the account of the networking system user.

7. The method of claim 5, wherein updating the account of the merchant to indicate that the at least one offer has been applied to the purchase comprises updating an offer report associated with the merchant.

8. The method of claim 7, wherein updating the offer report comprises adding information to the report comprising one or more of: a unique identifier associated with the at least one offer, a conversion rate associated with the at least one offer, redemption information associated with the at least one offer, a number of offers associated with the merchant that are still available, information associated with the purchase, or demographic information associated with the networking system user.

9. The method of claim 1, further comprising, prior to receiving the notification of the purchase:
providing a plurality of offers to the networking system user;
receiving a selection by the networking system user of the at least one offer; and
associating the at least one offer with an account of the networking system user.

10. The method as recited in claim 1, wherein receiving the notification of the purchase is in response to a use of a credit card associated with the networking system user at the point of sale associated with the merchant.

11. A system comprising:
at least one processor; and
at least one non-transitory computer-readable storage medium storing instructions thereon that, when executed by the at least one processor, cause the system to:
receive, from a payment processing system, a notification of a purchase initiated by a networking system user at a point of sale associated with a merchant;
identify, in response to the received notification, one or more offers available to the networking system user to apply to the purchase;
send, to the payment processing system, an indication of the one or more offers available to apply to the purchase;
receive, from the payment processing system, an indication of at least one offer applied to the purchase at the point of sale; and
update, in response to receiving the indication of the at least one offer applied to the purchase, a record at the networking system to indicate that the at least one offer has been applied to the purchase.

12. The system as recited in claim 11, wherein the notification of the purchase comprises an identifier for the networking system user, an identifier for the merchant, and information associated with the purchase.

13. The system as recited in claim 12, wherein identifying one or more offers available to apply to the purchase comprises:
identifying, based on the identifier for the networking system user, a networking system account of the networking system user;
identifying a plurality of offers associated with the networking system account; and
identifying, based on the identifier for the merchant and the information associated with the purchase, a subset of the plurality of offers associated with the networking system account that are applicable to the purchase.

14. The system as recited in claim 13, wherein:
sending the indication of the one or more offers available to apply to the purchase comprises sending, for each of the one or more offers, a unique identifier associated with the offer; and
receiving the indication of at least one offer applied to the purchase comprises receiving the unique identifier associated with the at least one offer.

15. The system as recited in claim 14, wherein updating the record to indicate that the at least one offer has been applied to the purchase comprises one or more of:
updating an account of the networking system user to indicate that the at least one offer has been applied to the purchase; or
updating an account of the merchant to indicate that the at least one offer has been applied to the purchase.

16. The system of claim 15, wherein updating the account of the networking system user to indicate that the at least one offer has been applied to the purchase comprises at least one of:
updating information associated with the at least one offer to indicate the at least one offer is redeemed;
increasing a punch-count associated with the offer; or
identifying one or more additional offers related to the at least one offer and associating the identified one or more additional offers with the account of the networking system user.

17. The system of claim 16, wherein updating the account of the merchant to indicate that the at least one offer has been applied to the purchase comprises updating an offer report associated with the merchant.

18. The system of claim 17, wherein updating the offer report comprises adding information to the report comprising one or more of: a unique identifier associated with the at least one offer, a conversion rate associated with the at least one offer, redemption information associated with the at least one offer, a number of offers associated with the merchant that are still available, information associated with the purchase, or demographic information associated with the networking system user.

19. The system of claim 18, further including instructions that, when executed by the at least one processor, cause the system to, prior to receiving the notification of the purchase:
provide a plurality of offers to the networking system user;
receive a selection by the networking system user of the at least one offer; and
associate the at least one offer with an account of the networking system user.

20. A non-transitory computer-readable medium storing instructions thereon that, when executed by at least one processor, cause a computer system to:
receive, from a payment processing system, a notification of a purchase initiated by a networking system user at a point of sale associated with a merchant;
identify, in response to the received notification, one or more offers available to the networking system user to apply to the purchase;
send, to the payment processing system, an indication of the one or more offers available to apply to the purchase;
receive, from the payment processing system, an indication of at least one offer applied to the purchase at the point of sale; and
update, in response to receiving the indication of the at least one offer applied to the purchase, a record at the networking system to indicate that the at least one offer has been applied to the purchase.
